(19) United States
(12) Patent Application Publication
(10) Pub. No.: US 2026/0043613 A1
(43) Pub. Date: Feb. 12, 2026

(54) SLAG DISCHARGE AMOUNT ESTIMATION METHOD

(71) Applicant: NIPPON STEEL CORPORATION, Chiyoda-ku, Tokyo (JP)

(72) Inventors: Yusuke HARADA, Chiyoda-ku, Tokyo (JP); Shinpei ONO, Chiyoda-ku, Tokyo (JP); Akihide KAIZAWA, Chiyoda-ku, Tokyo (JP); Teppei TAMURA, Chiyoda-ku, Tokyo (JP); Shohei KAKIMOTO, Chiyoda-ku, Tokyo (JP); Ryo YAMASHINA, Chiyoda-ku, Tokyo (JP); Masahiro TSUBOI, Chiyoda-ku, Tokyo (JP); Toru TASHIRO, Chiyoda-ku, Tokyo (JP); Ryosuke SASAKI, Chiyoda-ku, Tokyo (JP); Masato SUGIURA, Chiyoda-ku, Tokyo (JP)

(21) Appl. No.: 18/998,123

(22) PCT Filed: Aug. 2, 2023
(86) PCT No.: PCT/JP2023/028351

§ 371 Date: Jan. 24, 2025

(30) Foreign Application Priority Data
Sep. 15, 2022 (JP) 2022-147356
Dec. 28, 2022 (JP) 2022-211373

(51) Int. Cl. F27D 21/02; C21C 5/52

(52) U.S. Cl. CPC F27D 21/02; C21C 5/52; C21C 2005/5288; F27D 2021/026

(57) ABSTRACT

In a slag discharge amount estimation method, images of a slag flow flowing out from an outlet of a refining vessel are captured with a single imaging device. An upstream side of the slag flow is wider than a downstream side. Widths of the slag flow are found from the captured images, and a volume flow rate or mass flow rate of the slag flow is found. On the basis of the volume flow rate or the mass flow rate, a slag discharge amount is estimated.

### TECHNICAL FIELD

The present disclosure relates to a slag discharge amount estimation method.

### BACKGROUND ART

A process for conducting continuous refining is known in which, after desiliconizing and dephosphorizing treatments of molten iron in a converter, some of the slag is discharged (intermediate slag discharge) from a throat by tilting of the converter, leaving the molten iron in the converter, after which the converter is again set upright and new refining material is added. This process has lower heat losses and is economically superior to a process in which, after desiliconizing and dephosphorizing treatments of molten iron, the molten iron is discharged from a converter by tilting of the converter, the slag is separated, and decarburizing refining is conducted in a different converter. However, discharging solvent at an intermediate stage is disadvantageous in regard to precise slag composition control. To improve slag composition control precision, it is important to quantitatively identify intermediate slag discharge amounts. Japanese Patent Application Laid-Open (JP-A) Nos. H7-41813 and 2018-119195 are known as a quantitative assessment method and an estimation method for intermediate slag discharge amounts.

JP-A No. H7-41813 discloses a method of estimating a slag discharge amount by collecting slag in a slag pan provided on a slag carrier and weighing a converter slag discharge amount (the slag amount in the slag pan) with a weighing instrument disposed on a floor, and subtracting the estimated slag discharge amount from an estimated slag amount in the converter to find a remaining slag amount in the converter.

JP-A No. 2018-119195 discloses a method of, when discharging slag from a converter, finding a remaining slag amount in the converter from tilt angles of the converter when a slag flow begins and when the slag flow ends, using a value in which the remaining slag amount in the converter is subtracted from a theoretical slag amount as an intermediate slag discharge amount, and adjusting operation conditions in subsequent steps.

### SUMMARY OF INVENTION

### Technical Problem

In JP-A No. H7-41813, because a weighing instrument is used to find the intermediate slag discharge amount, there are issues with disposition and maintenance of the weighing instrument.

In JP-A No. 2018-119195, the intermediate slag discharge amount is found geometrically. Consequently, because there are large variations in both converter interior shapes and conditions of slag and metal (molten iron), the estimation precision of slag discharge amounts is low.

An object of the present disclosure is to estimate a slag discharge amount from a refining vessel at lower cost than when a weighing instrument is used and at higher accuracy than when a slag discharge amount is found geometrically.

### Solution to Problem

One aspect of the present disclosure is a slag discharge amount estimation method including:
capturing a slag flow flowing out from an outlet of a refining vessel with a single imaging device, an upstream side of the slag flow being wider in width than a downstream side; finding widths of the slag flow from captured images and finding a volume flow rate or mass flow rate of the slag flow; and estimating a slag discharge amount based on the volume flow rate or the mass flow rate that is found.

### Advantageous Effects of Invention

According to the present disclosure, a slag discharge amount from a refining vessel may be estimated at lower cost than when a weighing instrument is used and at higher accuracy than when a slag discharge amount is found by geometry.

### BRIEF DESCRIPTION OF DRAWINGS

FIG. 1A is a side view of a converter that is a refining vessel according to a first exemplary embodiment.

FIG. 1B is a side sectional diagram of the converter shown in FIG. 1A.

FIG. 2 is a side sectional diagram of the converter of the first exemplary embodiment, showing a state of molten material remaining in the converter that is tilted when slag is discharged from the converter.

FIG. 3A is a side sectional diagram of the converter of the first exemplary embodiment, showing a state in which oxygen is blown from a lance at molten iron charged in the converter.

FIG. 3B is a side sectional diagram of the converter, showing a state in which slag is being discharged from the tilted converter.

FIG. 4A is a side sectional diagram of the converter in FIG. 3B, showing a state in which oxygen is again being blown from the lance at molten iron remaining in the converter.

FIG. 4B is a side sectional diagram of the converter, showing a state in which molten steel is being removed from the tilted converter through a steel tap hole.

FIG. 5 is a plan view showing disposition of an imaging device relative to the converter in which the converter in the upright state is viewed from above.

FIG. 6 is a plan view showing disposition of the imaging device relative to the converter in which the converter in a tilted state is viewed from sideward.

FIG. 7A is a magnified elevation view showing a state in which slag is flowing out from a throat of the converter.

FIG. 7B is a linear sectional diagram cut along line 7B-7B in FIG. 7A, showing a cross-sectional shape at a predetermined position of the slag flow in FIG. 7A.

FIG. 8 is a graph showing a relationship between slag discharge volumes according to image analysis and slag discharge volumes according to geometric calculation.

FIG. 9 is a diagram showing structures of a control device according to the exemplary embodiment.

FIG. 10 is a schematic view of an electric furnace.

FIG. 11 is a schematic view showing a tilted slag discharge state of the electric furnace.

FIG. 12 is a schematic view showing a state in which an estimation system detects a slag flow and estimates a flow rate.

FIG. 13 shows measurement results of slag flow speeds (mass flow rates) in one of Test Examples 1 to 10.

FIG. 14 shows measurement results of cumulative slag flow amounts in one of Test Examples 1 to 10.

FIG. 15 depicts results showing a relationship between actual slag flow amounts and estimated slag flow amounts found by Examples.

FIG. 16 is an elevation view in which a refining vessel is seen from in front, showing a state in which a slag flow flowing out from the refining vessel is divided.

FIG. 17 is an elevation view in which the refining vessel is seen from in front, showing a state in which a slag flow flowing out from the refining vessel is not divided.

FIG. 18 is a graph showing a relationship between actual slag discharge amounts and estimated slag discharge amounts found by Examples and Comparative Examples.

FIG. 19 is a side view in which a refining vessel is seen from sideward, showing a state in which a slag flow is flowing out from the refining vessel.

FIG. 20 is a graph showing average estimation errors of slag discharge amount estimations in Examples, Reference Examples and Comparative Examples.

FIG. 21 is a graph showing a relationship between actual slag discharge amounts and estimated slag discharge amounts found by the Examples, Reference Examples and Comparative Examples.

FIG. 22 is a flowchart for setting widths L in expression (8) when a slag discharge amount estimation system employs projection method (2).

FIG. 23 is a graph showing changes over time in width of a slag flow in one Test Example of Examples 1 to 11.

FIG. 24 is a graph showing changes over time in width of a slag flow in one Test Example of Examples 12 and 13.

FIG. 25 depicts results showing a relationship between actual slag discharge amounts and estimated slag discharge amounts found by Examples.

### DETAILED DESCRIPTION

Below, modes for embodying the technology of the present disclosure are described with reference to the drawings. In the drawings, structural elements being indicated with the same reference symbols means that those structural elements are the same or similar. In the exemplary embodiments described below, duplicative descriptions and reference symbols may be omitted. The drawings used for the descriptions below are all schematic illustrations: Dimensional relationships of elements, proportions of elements and so forth illustrated in the drawings do not necessarily match reality. Moreover, dimensional relationships of elements, proportions of elements and so forth do not necessarily match between plural drawings.

### First Exemplary Embodiment

A slag discharge amount estimation method according to a first exemplary embodiment of the present disclosure is described.

First, a converter 20 that serves as an example of a refining vessel used in the slag discharge amount estimation method and a refining method according to the present exemplary embodiment are described.

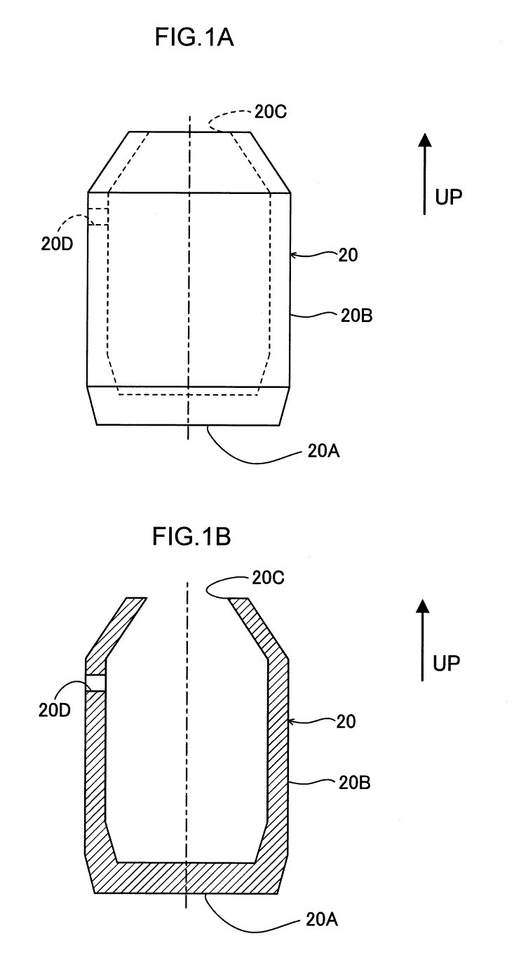

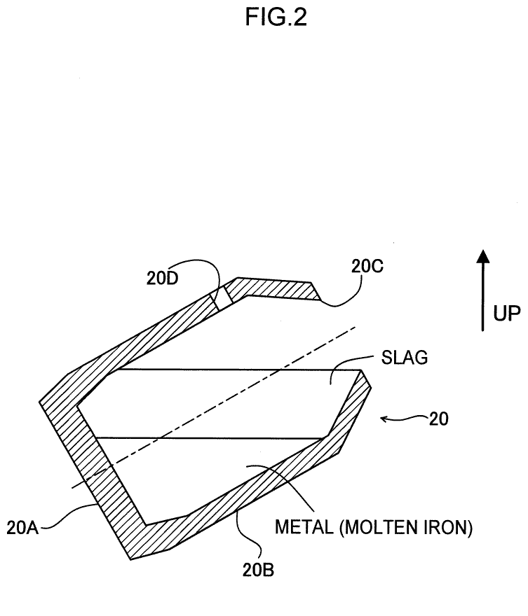

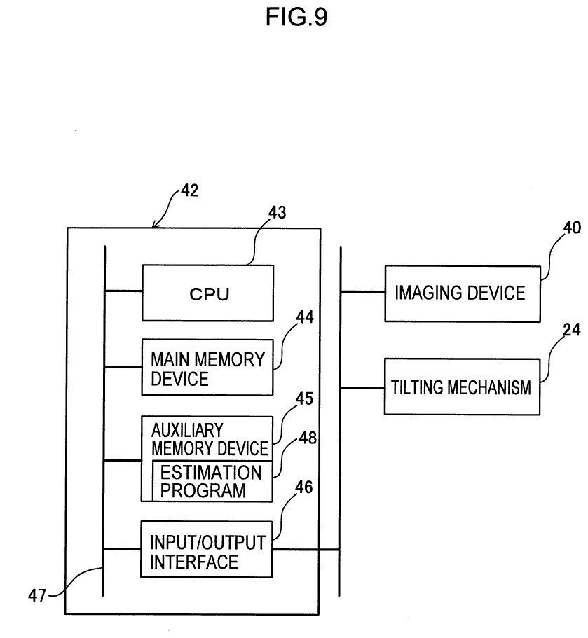

As shown in FIG. 1 to FIG. 9, the converter 20 is provided with a floor portion 20A, a furnace wall 20B, a throat 20C, and a steel tap hole 20D provided in the furnace wall 20B. The converter 20 is configured to be tilted by a tilting mechanism 24 (see FIG. 9).

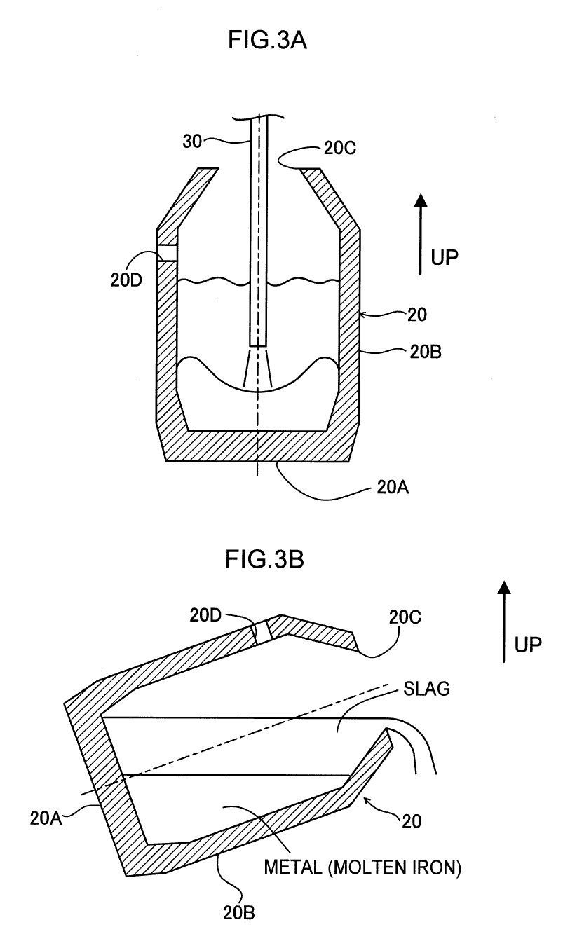

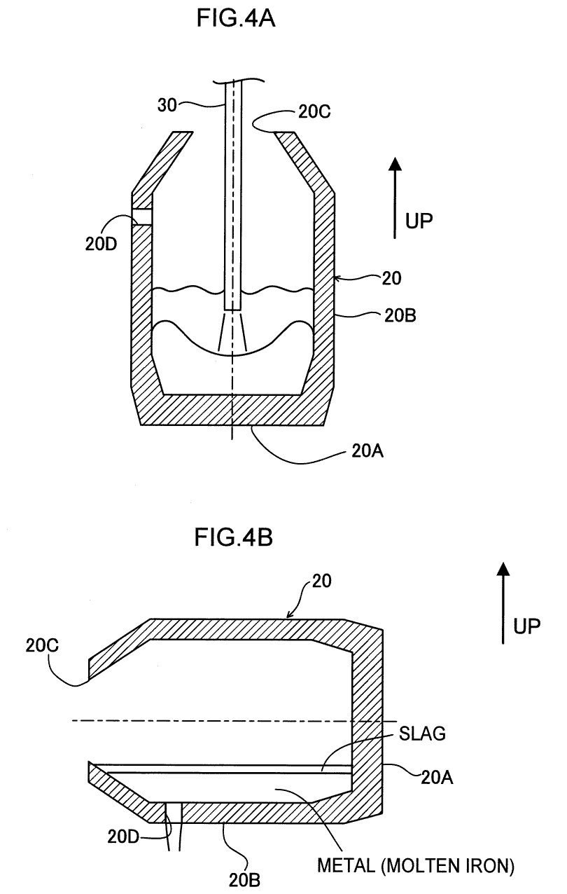

During refining using the converter 20, firstly molten iron is charged into the converter 20, and a first refining material is added to the charged molten iron. The first refining material is a material (oxide) used for removing phosphorus, silicon and the like, and carbon, from the molten iron charged in the converter 20. For example, the first refining material encompasses calcium oxides (CaO) such as quicklime, limestone and the like, magnesium oxides (MgO), iron oxides (FeO), and combinations of one or multiple of these compounds. Then, as illustrated in FIG. 3A, a lance 30 is inserted into the converter 20 through the throat 20C. A pressurized gas (for example, oxygen) is blown out from the lance 30 onto the molten iron in the converter 20. The molten iron and first refining material in the converter 20 are agitated by the blowing of the gas, and phosphorus, silicon and the like and carbon are oxidized and extracted from the molten iron. The lance 30 is withdrawn from the converter 20 and, as illustrated in FIG. 3B, the converter 20 is tilted (tilted to the right side in FIG. 3B). As a result of this tilting of the converter 20, slag (intermediate slag) with high concentrations of phosphorus, silicon and the like flows down from the throat 20C to a slag pan 22 disposed below the converter 20, leaving the molten iron in the converter 20. After the intermediate slag discharge, as illustrated in FIG. 4A, the converter 20 is returned to an upright state. The meaning of the term “upright state” of the converter 20 as used here indicates a state in which the throat 20C is oriented upward. Next, a second refining material is added to the molten iron in the converter 20. The second refining material is a material (oxide) used for removing phosphorus, carbon and the like from the molten iron that remains in the converter 20 after the intermediate discharge. The second refining material encompasses, for example, the same materials as the first refining material. Then the lance 30 is inserted through the throat 20C into the converter 20 and pressurized gas is blown from the lance 30 onto the molten iron in the converter 20. The molten iron and second refining material in the converter 20 are agitated, and phosphorus, carbon and the like that still remain in small amounts in the molten iron are extracted from the molten iron. The lance 30 is withdrawn from the converter 20 and, as illustrated in FIG. 4B, the converter 20 is tilted to the opposite side from the tilting for intermediate discharge (i.e., tilted to the left side in FIG. 4B). As a result of this tilting of the converter 20, molten iron flows out through the steel tap hole 20D. After the molten iron is taken out from the converter 20 (steel tapping), slag remaining in the converter 20, which has lower concentrations of phosphorus and silicon and a high concentration of CaO, is reused by being included in the first refining material during subsequent refining. Refining processes that employ this converter 20 include, for example, the MURC process and the double slag process.

Now, the slag discharge amount estimation method using the converter 20 according to the present exemplary embodiment is described. In the slag discharge amount estimation method according to the present exemplary embodiment, image analysis is used to estimate a slag discharge amount. More specifically, a volume of discharged slag is found from images of a slag flow during intermediate slag discharge, and a slag discharge amount (slag discharge mass) is estimated from the volume.

### —Slag Discharge Amount Estimation Method—

The slag discharge amount estimation method according to the present exemplary embodiment includes a capturing step, a finding step and an estimating step.

### —Capturing Step—

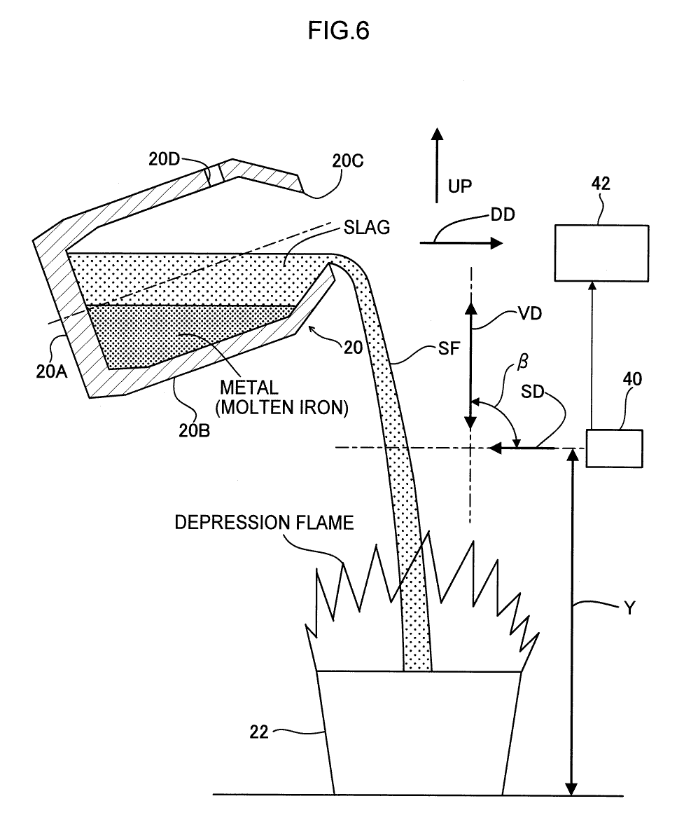

First, a slag flow SF flowing out through the throat 20C of the converter 20 is captured. More specifically, as illustrated in FIG. 6, an imaging device 40 captures the slag flow SF flowing out (flowing down) toward the slag pan 22 from the throat 20C of the converter 20 that is tilted for intermediate slag discharge. The imaging device 40 that is employed may be, for example, a CCD camera, a CMOS camera or the like. Image information captured by the imaging device 40 is sent to a computer 42, which is described below. The imaging device 40 and the computer 42 are connected by wire or connected by wireless.

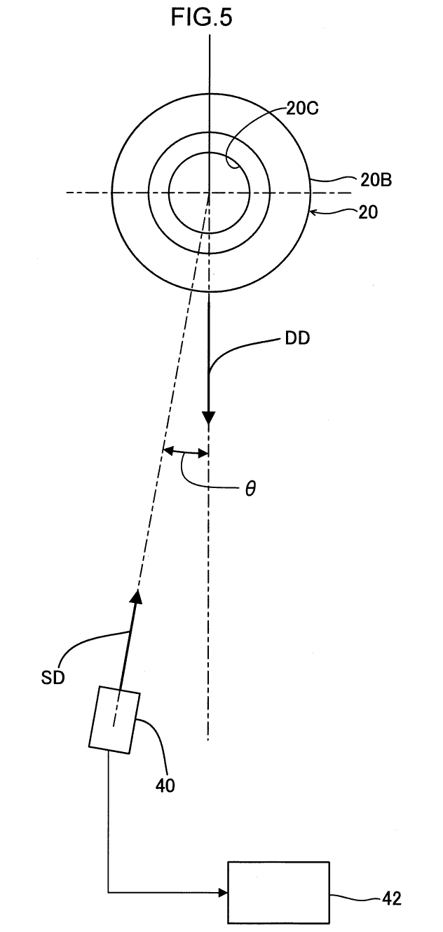

As shown in FIG. 5, an imaging direction SD of the imaging device 40 capturing the slag flow SF is angled in plan view relative to a discharge direction of the converter 20. More specifically, viewed from above the converter 20 in the upright state, the direction in which the converter 20 tilts at the time of intermediate slag discharge, which is to say the direction in which the slag pan 22 is disposed relative to the converter 20, is the discharge direction. Below, the discharge direction of the converter 20 is indicated with the reference symbol DD. The imaging direction SD of the imaging device 40 is an optical axis direction of the imaging device 40. When the imaging device 40 is a camera, the imaging direction is the optical axis direction.

The imaging direction SD of the imaging device 40 may be angled at an angle θ in plan view relative to the discharge direction DD of the converter 20. This angle θ is preferably set in a range from 0° to 70°, and is more preferably set in a range from 20° to 50°. In the present exemplary embodiment, the angle θ is set to 45°, but the present disclosure is not limited thus. Because the imaging device 40 is disposed in this manner such that the imaging direction SD of the imaging device 40 capturing the slag flow SF is angled relative to the discharge direction DD of the converter 20 in plan view, the imaging device 40 is less likely to be affected by a depression flame, which is described below.

As shown in FIG. 6, seen from sideward, the imaging direction SD of the imaging device 40 capturing the slag flow SF is inclined at an angle β relative to a vertical direction VD. This angle β is preferably set in a range from 70° to 110°, and is more preferably set in a range from 80° to 100°. In the present exemplary embodiment the imaging direction SD is orthogonal to the vertical direction VD; that is, the angle β is 90°. Setting the angle β to 90° is more preferable. When the angle β is 90°, the imaging direction SD is a horizontal direction.

As shown in FIG. 6, a disposition height Y of the imaging device 40 is preferably set to a height to be unaffected by the depression flame. The meaning of the term “depression flame” as used herein is intended to include flames caused by a reaction between the slag and a slag depressant. When, for example, the imaging device 40 is disposed at a position lower than the depression flame, the imaging device 40 is set to an elevation angle pointing to above the depression flame to capture the slag flow SF.

### —Finding Step—

Then, a volume flow rate or mass flow rate of the slag flow SF is found from the captured images. In the present exemplary embodiment, it is the volume flow rate of the slag flow SF that is found from the captured images. More specifically, the computer 42 receives image information captured by the imaging device 40 of the slag flow SF and the computer 42 performs image analysis to find the volume flow rate of the slag flow SF. The image information sent from the imaging device 40 may be image information of static images captured at predetermined intervals (for example, 1 s intervals), and may be image information of a video image. When the image information sent from the imaging device 40 is image information of static images, image analysis is performed on each of the static images. Alternatively, when the image information sent from the imaging device 40 is image information of a video image, static images are extracted from the video image at predetermined intervals (for example, 1 s intervals) and image analysis is performed on each of the extracted static images.

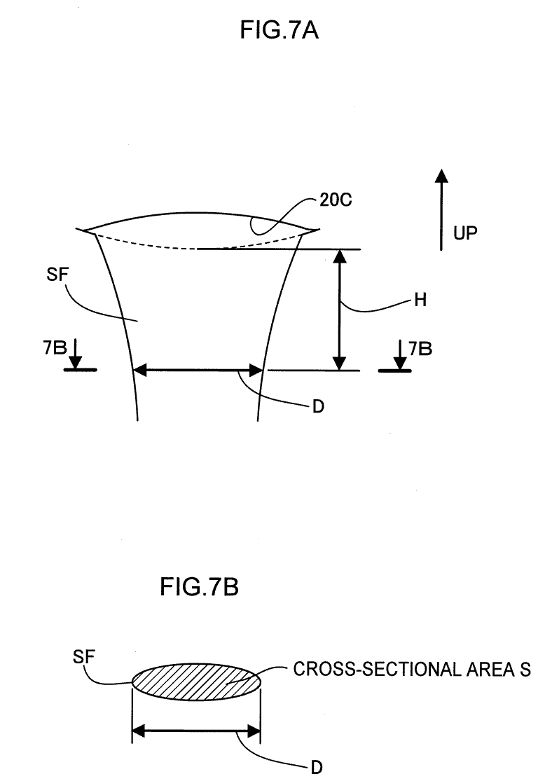

In image analysis of a static image by the computer 42, firstly the static image is binarized. Then, a length of a high-brightness portion in an analysis region that is specified beforehand is measured to serve as an apparent length of the slag flow SF. As depicted in FIG. 7A, the length of the high-brightness portion of the slag flow SF may also be referred to as the width of the slag flow SF. The analysis region of the static image by the computer 42 is between the throat 20C, which is a flow start position of the slag flow SF, and the slag pan 22. The analysis region needs to be set to a height that is not affected by a depression flame rising from the slag pan 22. From the static image captured by the imaging device 40, the computer 42 finds a width L (in m) of the slag flow SF at a predetermined height and a distance H (m) from the position of measurement at which the width L is found to the flow start position from the throat 20C of the slag flow SF.

Then, a cross-sectional area S (m²) of the slag flow SF at the position of measurement of the width L is found in the form απL². To be more specific, the cross-sectional area S is found by the computer 42. The parameter α is a shape correction coefficient of the slag flow SF. If the cross-sectional shape of the slag flow SF is a circle, α=1/4 (see FIG. 7B).

Next, a flow speed V (m/s) is found from the captured images. More specifically, the computer 42 may set an assumed freefall rate of the slag flow SF of (2gH)^{0.5} as the flow speed V (m/s) of the slag flow SF at the position of measurement of the width L of the slag flow SF, or the computer 42 may find a movement distance of the slag flow SF by pattern matching from two or more of the images, and find the flow speed V (m/s) by dividing the movement distance of the slag flow SF by a difference (s) between the capture times of the images providing the movement distance.

A volume flow rate Q (m³/s) of the slag flow SF is found by the following expression (1). To be more specific, the volume flow rate Q is found by the computer 42 using the above-mentioned flow speed V and cross-sectional area S.

$$Q = SV = α π {L}^{2} V = α π {{L}^{2} ( 2 gH )}^{0.5} \qquad ( 1 )$$

### —Estimating Step—

Then, a slag discharge amount (slag discharge mass) from the converter 20 is estimated on the basis of the volume flow rate or the mass flow rate. In the present exemplary embodiment, the intermediate slag discharge amount from the converter 20 is estimated on the basis of the volume flow rate found by the steps described above.

First, a slag bulk density ρ (kg/m³) is used to convert the volume flow rate Q to a mass flow rate ρQ (kg/s). The slag bulk density is found from, at least, a tilt angle of the converter 20 when the flow of the slag flow SF starts, a shape of the converter 20, a volume of the converter 20, an estimate M_{S} of slag mass in the furnace, and a slag volume in the furnace, which is found geometrically. To be more specific, the computer 42 uses at least the tilt angle of the converter 20, the shape of the converter 20, the volume of the converter 20 and the bulk density ρ to convert the volume flow rate Q to the mass flow rate ρQ. The estimate M_{S} is found from, for example, an (actual) mass of the first refining material charged into the converter 20, a mass (found by calculation) of oxides produced by oxidation from the molten iron (for example, silicon dioxide (SiO₂), phosphorus pentoxide (P₂O₅), manganese oxide (MnO), or a combination of one or multiple of these oxides), and an (assumed) mass of slag being reused from a previous occasion.

Calculation of bulk density: As illustrated in FIG. 1B, the bulk density ρ of the slag is found by representing an effective furnace volume of the converter 20 at the time the slag starts to flow from the throat 20C of the tilted converter 20 by V_{DS}, representing a volume of the molten iron by V_{M}, representing a volume of slag by V_{S}, finding the volume of the slag V_{S} by V_{S}=V_{DS}−V_{M}, setting M_{S} as the mass of the slag, and finding the bulk density by ρ=M_{S}/V_{S}.

V_{S}+V_{M} may be calculated by CAD, geometry or the like from plans of the converter 20 when the tilt angle of the converter 20 has been determined.

A molten steel mass approximately equals the mass of feed materials (molten iron plus scrap). V_{M} may be found by multiplying molten steel density by the (actual) mass of feed materials.

The shape of the converter 20 is the furnace interior shape. In FIG. 1A, this shape is depicted by broken lines. That is, the furnace interior shape means a shape that includes the shape of inner faces of the furnace wall 20B and the shape of the inner face of the floor portion 20A.

The bulk density ρ of the slag may be found by representing a slag height (m) in the converter 20 when refining begins by h₀, representing the slag height (m) when the width L of the slag flow is measured by h, representing a gas phase fraction in the slag by φ, finding the gas phase fraction φ by φ=(h₀−h)/h₀×100, representing a density of uniform liquid slag by ρL (kg/m³), and finding the bulk density ρ by ρ=ρL×(100−φ)/100.

The slag discharge mass (kg) is found from an integrated value ΣρQ (kg) of the mass flow rate ρQ. In the slag discharge amount estimation method according to the present exemplary embodiment, volume flow rates Q of discharged slag may be found on the basis of images of the slag flow SF during the intermediate discharge, and the slag discharge mass may be found from the volume flow rates Q.

The parameter α in expression (1) is found by parameter fitting so as to fit slag discharge mass (kg) found using a weighing instrument (not shown in the drawings) at times of discharge from the converter 20 with integrated values ΣρQ (kg) of mass flow rates ρQ (kg/s).

Now, a refining process in the converter 20 according to the present exemplary embodiment is described.

In the refining process according to the present exemplary embodiment, operation conditions in a subsequent step are set on the basis of an intermediate slag discharge amount estimated by the slag discharge amount estimation method. These operation conditions include a type of refining material to be added to the molten metal (molten iron) in the converter 20 and an addition amount of the refining material.

Now, the computer 42, which controls the type of refining material added to the converter 20 and the addition amount, is described. The computer 42 is successively sent image information of a slag flow SF captured by the imaging device 40 as illustrated in FIG. 5 and FIG. 6. The computer 42 finds volume flow rates Q of the slag flow SF on the basis of the received image information. The computer 42 then finds an intermediate slag discharge mass based on the volume flow rates Q.

The computer 42 specifies the operation conditions of the subsequent step on the basis of the intermediate slag discharge amount that is found. More specifically, the computer 42 determines the type of refining material to be added to the molten iron in the converter 20 and the addition amount of the refining material, and operates an addition device (not shown in the drawings) to add the refining material to the molten iron in the converter 20. The computer 42 also controls the tilting mechanism 24 of the converter 20.

As shown in FIG. 9, the computer 42 is provided with a central processing unit (CPU) 43, a main memory device 44 that provides a temporary memory space, an auxiliary memory device 45 that provides a nonvolatile memory space, and an input/output interface (I/F) 46. The CPU 43, main memory device 44, auxiliary memory device 45 and input/output interface 46 are connected to one another via a bus 47.

The auxiliary memory device 45 may be realized by a hard disk drive (HDD) solid-state drive (SSD), flash memory or the like. An estimation program 48 for causing the computer 42 to function as an intermediate slag discharge amount estimation device of the converter 20 is memorized in the auxiliary memory device 45. When the CPU 43 reads the estimation program 48 from the auxiliary memory device 45, loads the estimation program 48 into the main memory device 44, and sequentially executes processes described in the estimation program 48, the computer 42 functions as the intermediate slag discharge amount estimation device of the converter 20.

The input/output interface 46 is connected to the imaging device 40, forming a configuration in which image information captured by the imaging device 40 is stored to the auxiliary memory device 45 via the input/output interface 46 and image analysis of the image information is performed by the CPU 43. The input/output interface 46 is also connected to the tilting mechanism 24 of the converter 20. More specifically, the input/output interface 46 is connected to a tilting control device of the tilting mechanism 24. The tilting control device is configured so as to operate the tilting mechanism 24 and control tilt angles of the converter 20 in accordance with commands from the computer 42.

Now, operational effects of the present exemplary embodiment are described.

The estimation method according to the present exemplary embodiment uses image analysis to find intermediate slag discharge amounts of the converter 20. Therefore, equipment costs are lower than when, for example, using a weighing instrument to find intermediate slag discharge amounts. Moreover, unlike a mechanical measurement method, the estimation method is unaffected by thermal deformation, equipment ageing and the like. Therefore, equipment maintenance is simpler. In contrast to a weight measurement method using a weighing instrument that cannot provide an accurate measurement value until the measurement value is stable after the completion of a slag discharge, because the estimation method according to the present disclosure conducts measurements optically, the estimation method may find measured values and integrated values even during a discharge. Therefore, reliable intermediate slag discharge amounts may be found.

The estimation method according to the present exemplary embodiment may estimate intermediate slag discharge amounts from the converter 20 with higher precision than when slag discharge amounts are found geometrically. More specifically, when a slag discharge amount is found by geometry, estimation precision may fall due to variations in both the furnace interior shape and slag and metal conditions. In contrast, the estimation method according to the present exemplary embodiment may use the imaging device 40 to conduct measurements in the form of volumes of slag flow, which reflect the effects of these variations. Therefore, estimation precision is improved.

In a conventional slag discharge amount estimation method, subsequent processing may be optimized by taking account of a resulting intermediate slag discharge amount. By contrast, in the estimation method according to the present exemplary embodiment, intermediate slag discharge amounts may be known in addition to the processing described above. Therefore, slag discharge amounts themselves may be regulated. More specifically, a conventional method cannot implement regulation to stop a slag discharge when a slag discharge mass reaches a predetermined value; only an actually discharged slag weight can be obtained. By contrast, the estimation method according to the present exemplary embodiment may implement regulation to stop a slag discharge when a discharged slag discharge volume is a predetermined value. A conventional method may both stabilize and improve subsequent steps by quantifying the result of an intermediate slag discharge but, in addition to the above descriptions, the estimation method according to the present disclosure may quantify intermediate slag discharges. Therefore, intermediate slag discharges themselves may be both stabilized and improved.

In the estimation method according to the present exemplary embodiment, because the imaging device 40 capturing the slag flow SF is disposed such that the imaging direction SD of the imaging device 40 is angled relative to the discharge direction DD of the converter 20 in plan view, the imaging device 40 is unlikely to be affected by a depression flame.

In the estimation method according to the present exemplary embodiment, when the imaging direction SD of the imaging device 40 capturing the slag flow SF is orthogonal to the vertical direction VD as seen from sideward, image information with high precision is provided by the imaging device 40.

In the exemplary embodiment described above, the imaging device 40 and the computer 42 are connected by wire or by wireless, but the present disclosure is not limited thus. For example, a removable image memorization medium may be taken out from the imaging device 40 and connected to the CPU 43 via the input/output interface 46.

In the exemplary embodiment described above, the imaging direction SD of the imaging device 40 is angled relative to the discharge direction DD, but the present disclosure is not limited thus. For example, if the imaging device 40 is disposed higher up and captures the slag flow SF flowing down from the throat 20C from above, the imaging direction SD of the imaging device 40 and the discharge direction DD may be in the same direction.

In the exemplary embodiment described above, a volume flow rate of a slag flow SF is found by image analysis and a slag discharge amount (slag discharge volume) is estimated from the volume flow rate, but the present disclosure is not limited thus. For example, a mass flow rate may be found together with a volume flow rate of a slag flow SF by image analysis, and a slag discharge amount may be estimated from the mass flow rate.

In the refining process of the converter 20 according to the exemplary embodiment described above, volume flow rates of a slag flow SF are found by image analysis, a slag discharge amount (slag discharge volume) is estimated from the volume flow rates, and operation conditions of a subsequent step are specified on the basis of the estimated intermediate slag discharge amount, but the present disclosure is not limited thus. For example, a slag flow SF flowing out from the throat of the converter 20 may be captured, widths L of the slag flow SF may be estimated from the captured images, and operation conditions of a subsequent step may be specified on the basis of the widths L that are found. That is, a configuration is possible that utilizes the width L of the slag flow SF as a slag discharge parameter. These operational conditions include a type of refining material to be added to the molten metal (molten iron) in the converter 20 and an addition amount of the refining material. More specifically, when the slag discharge parameter is within a (standard) range specified in advance, a charging amount of auxiliary feed material (principally CaO) is set to a specified amount that is set beforehand. On the other hand, when the slag discharge parameter is below this range, the charging amount of auxiliary feed material (principally CaO) is set to more than the specified amount. When the slag discharge parameter is above this range, the charging amount of auxiliary feed material (principally CaO) is set to less than the specified amount, or the charging amount of auxiliary feed material (principally CaO) is set to the specified amount and a SiO₂ source is also charged. The term “SiO₂ source” as used here indicates SiO itself, a compound including SiO₂, or an alloy containing Si (which oxidizes to SiO₂). That is, when a slag discharge is small, more SiO₂ is present in the furnace, so more CaO is to be charged. When a slag discharge is large, CaO is excessive, so CaO is decreased or SiO₂ is increased to achieve a balance. Thus, the ratio of CaO concentration to SiO₂ concentration in the slag is regulated to a certain range, and the phosphorus extraction effect may be maximized. When widths L of the slag flow SF are used as a slag discharge parameter as described above, calculation of the slag bulk density is unnecessary and data processing work is simpler. In particular, when operations with very little variation in slag density are being conducted, widths L and mass flow rates ρQ of slag flows SF have close to a one-to-one relationship. Therefore, utilizing widths L of the slag flows SF as the slag discharge parameter may simplify data processing work.

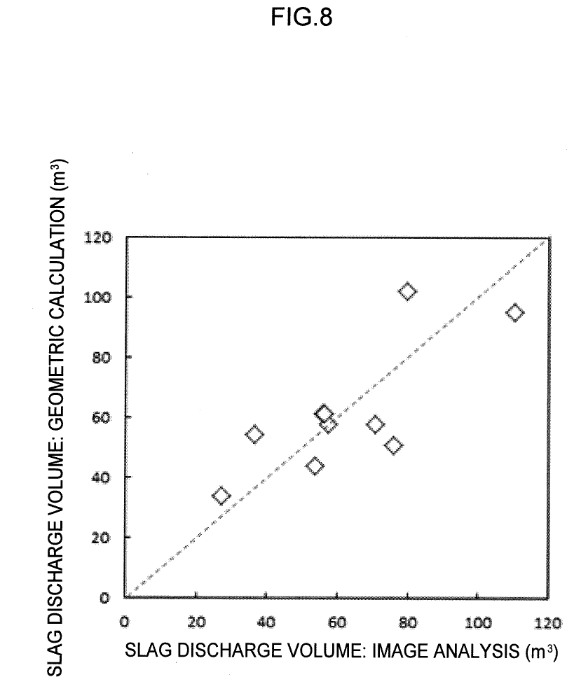

Now, a relationship between slag discharge volumes found by the image analysis of the present exemplary embodiment and slag discharge volumes found by geometric calculations is described on the basis of the below Table 1 and FIG. 8.

Slag volumes found by image analysis in Example 1 to Example 10, which use the estimation method according to the present exemplary embodiment, slag discharge volumes found by geometric calculations, and actually measured slag discharge masses are shown in Table 1 below. The discharge start tilt angle referred to in Table 1 refers to the tilt of a converter at the start of a slag discharge, and the discharge end tilt angle referred to in Table 1 refers to the tilt of the converter at the end of the slag discharge.

TABLE 1

| | | | | | Slag | | | |
|---|---|---|---|---|---|---|---|---|
| | | | | Slag | volume: | | | |
| | Discharge | Discharge | | volume: | image | Discharge | Bulk | Slag |
| | start tilt | end tilt | | geometric | analysis | duration | density | mass |
| | angle (°) | angle (°) | α | (m³) | (m³) | (s) | (kg/m³) | (kg) |
| Example 1 | 77 | 90 | 0.175 | 44.3 | 53.5 | 283 | 276 | 9021 |
| Example 2 | 75 | 90 | 0.175 | 51.1 | 76.1 | 195 | 389 | 14091 |
| Example 3 | 72 | 90 | 0.175 | 61.3 | 55.7 | 176 | 207 | 9910 |
| Example 4 | 74 | 90 | 0.175 | 54.5 | 36.6 | 211 | 312 | 9871 |
| Example 5 | 73 | 90 | 0.175 | 57.9 | 57.4 | 263 | 218 | 8347 |
| Example 6 | 80 | 90 | 0.175 | 34.0 | 27.3 | 152 | 405 | 8765 |
| Example 7 | 72 | 90 | 0.175 | 61.3 | 56.2 | 249 | 288 | 12544 |
| Example 8 | 73 | 90 | 0.175 | 57.9 | 70.6 | 228 | 137 | 11956 |
| Example 9 | 60 | 90 | 0.175 | 102.1 | 79.8 | 224 | 162 | 9538 |
| Example 10 | 62 | 90 | 0.175 | 95.3 | 110.1 | 271 | 109 | 10841 |

FIG. 8 shows the relationship between slag discharge volumes found by image analysis and slag discharge volumes found by geometric calculation, based on the slag discharge volumes found by image analysis and slag discharge volumes found by geometric calculation for Example 1 to Example 10 in Table 1. As shown in FIG. 8, there are some degrees of variation between the slag discharge volumes found by image analysis and slag discharge volumes found by geometric calculation, but it can be seen that the values are generally close.

In the exemplary embodiment described above, the converter 20 is used as an example of a refining vessel, but the present disclosure is not limited thus. For example, an electric furnace, a molten steel ladle and a torpedo wagon (torpedo car) may be used as examples of the refining vessel.

### Second Exemplary Embodiment

Now, a slag discharge amount estimation method according to a second exemplary embodiment of the present disclosure is described.

First, an electric furnace 101 is described as an example of a refining vessel used in the slag discharge amount estimation method and a slag discharge amount estimation system 110 (which may below be referred to as the “estimation system 110”) according to the present exemplary embodiment.

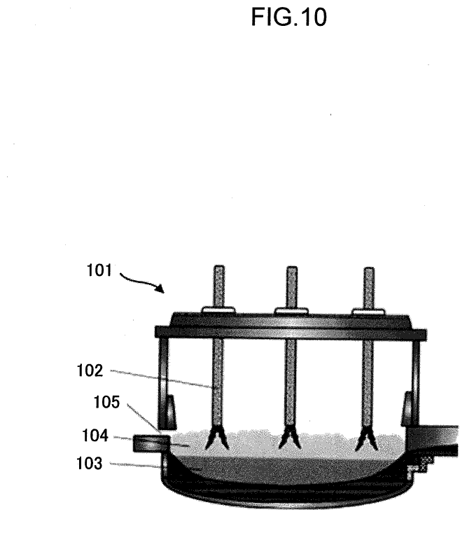

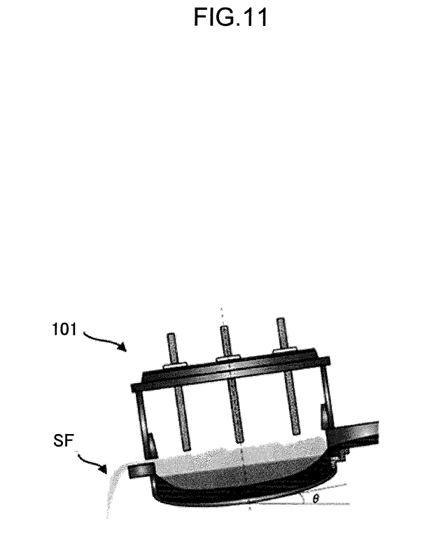

FIG. 10 shows a schematic diagram of the example electric furnace 101. The electric furnace 101 uses plural electrodes 102 and heats a refining material together with high-temperature molten material 103 (for example, molten steel, molten iron or the like) to implement refining. As illustrated in FIG. 10, the electrodes 102 are submerged in the high-temperature molten material 103 and current flows through the electrodes 102, heating the high-temperature molten material 103 and implementing refining such as decarburization and the like. At this time, slag 104 is generated as a byproduct. The slag 104 that is produced flows (is discharged) out of the electric furnace 101 as appropriate through a slag door 105. The flowing out of the slag 104 is implemented by, for example, pouring, scraping, discharge by tilting or the like. FIG. 11 is a schematic view showing a state of the electric furnace 101 implementing a discharge by tilting. In this discharge by tilting, the electric furnace 101 is tilted to a predetermined angle θ, enabling the slag 104 to flow outside through the slag door 105. The slag 104 flowing out is collected in a slag ladle 106 or the like disposed below the electric furnace 101.

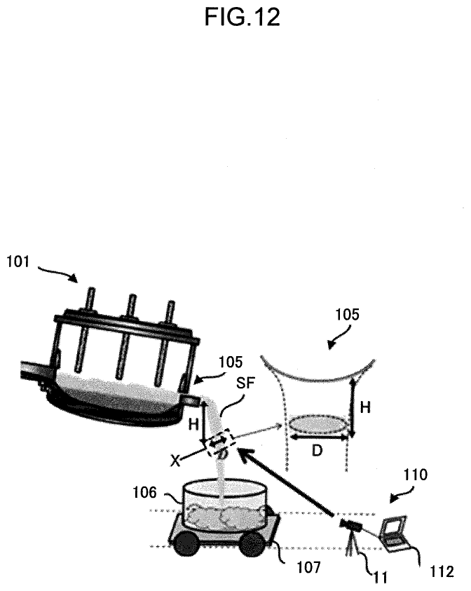

The estimation system 110 according to the present exemplary embodiment detects the slag 104 flowing out from the slag door 105, without contact, and estimates an outflow amount. FIG. 12 is a schematic view showing a state in which the estimation system 110 detects the slag 104 (a slag flow SF) flowing out and estimates the outflow amount.

As shown in FIG. 12, the slag 104 flowing out through the slag door 105 of the electric furnace 101 is collected in the slag ladle 106 that is disposed at the lower side relative to the electric furnace 101. The slag ladle 106 is placed on a slag receiving car 107, and may transport the collected slag 104 to another location when appropriate. The estimation system 110 according to the exemplary embodiment detects the slag 104 (the slag flow SF) flowing out and estimates the outflow amount of the slag 104 while the slag 104 is falling from the slag door 105 to the slag ladle 106.

The estimation system 110 is provided with an imaging device 111 and a computer 112. The imaging device 111 has functions for capturing the slag flow SF. The computer 112 is a processing device including a detection section that detects the slag flow SF flowing out from the electric furnace 101 by receiving image information from the imaging device 111 and analyzing the received image information. The computer 112 is further provided with a calculation section that finds volume flow rates of the slag flow SF from the captured images and an estimation section that estimates a slag amount flowing out from the electric furnace 101 on the basis of the volume flow rates.

First, the imaging device 111 is described. The imaging device 111 is not particularly limited provided the device is capable of capturing the slag flow SF. The imaging device 111 is disposed at a front face side of the slag door 105 and captures the slag flow SF from the front.

### —Detection Section—

The detection section detects the slag flow SF flowing out from the electric furnace 101. Detection of the slag flow SF may be implemented by monitoring at least a region in which the slag 104 flows out (region X). While monitoring and capturing the slag flow SF, the imaging device 111 may utilize an optical filter or the like to block light from lighting and the like.

The meaning of “a region in which the slag 104 flows out (region X)” is intended to include a region that the detection section may detect when the slag 104 flows out from the electric furnace 101. A range of the region X in the horizontal direction encompasses widths in which the slag 104 flows out, and a range of the region X in the vertical direction includes at least a portion of a range between the slag door 105 that is the slag outlet and an upper end of the slag ladle 106. The meaning of “widths in which the slag 104 flows out” is intended to include lengths in the horizontal direction of the slag flow SF to be estimated when the slag 104 flows out from the electric furnace 101. Estimated values of width of slag flows may be obtained experimentally or by simulation.

With a view to preventing misdetection of a slag flow SF, the horizontal direction range of the region X should be at least the width of the slag flow SF and not more than 1500% of the width of the slag flow SF. Similarly with a view to preventing misdetection of a slag flow SF, the vertical direction range of the region X should be at least 10% of a length between the slag door 105 and the upper end of the slag ladle 106 and not more than 500% of this length. FIG. 12 depicts an example of the region X.

Detection of a slag flow SF may be implemented by detecting high-brightness material appearing in the region X. That is, the detection section measures brightness values in the region X. As the brightness values, the detection section employs brightness values expressed in 256 gradations (0 to 255).

The meaning of “high-brightness material” is intended to include material with brightness values of at least a predetermined value higher than the background in the region X, and more specifically to include the slag flow SF. For example, the detection section may detect high-brightness material as the slag flow SF when brightness values are between 30 and 255. The meaning of the term “background” is intended to include portions in the region X excluding the high-brightness material, for example, portions with brightness values between 0 and 29. Brightness values in the region X are monitored by the imaging device 111 in this manner, and the computer 112 is utilized to detect high-brightness material (the slag flow SF) with higher brightness values than the background.

It is sufficient that the high-brightness material has brightness values higher than the background, but when a difference in the brightness values between the high-brightness material and the background is small, it may not be possible to suitably detect the slag flow SF. Accordingly, with a view to detecting the slag flow SF easily, the detection section may determine that a high-brightness material with brightness values at least 30 higher than the background is the slag flow SF. With a view to raising detection precision further, the computer 112 may determine that a high-brightness material with brightness values at least 50 higher than the background is the slag flow SF.

With a view to preventing misdetections, the high-brightness material may be determined to be the slag flow SF when an area of the high-brightness material is at least 0.1% of the total area of the region X. With a view to even further preventing misdetections, the high-brightness material may be determined to be the slag flow SF when the area of the high-brightness material is at least 0.5% of the total area of the region X.

### —Image Capture Section—

An image capture section captures the slag flow SF. Captured images are sent to the computer 112 (the calculation section). Capture of the slag flow SF by the image capture section may continue until the computer 112 can no longer detect the slag flow SF. A number of images to be sent is not particularly limited, but should be at least two.

A format of images of the slag flow SF from the image capture section may be static images and may be a video image. When static images are captured, the images are captured at a rate of at least one per second. With a view to improving estimation precision of outflow amounts of the slag 104, the static images may be captured at a rate of 10 or more per second. When a video image is captured, static images are extracted from the captured video image at a rate of at least one per second. With a view to improving estimation precision of outflow amounts of the slag 104, the static images may be extracted from the captured video image at a rate of 10 or more per second.

It is sufficient if the computer 112 has a similar structure to an ordinary computer. In order to collect image data from the imaging device 111, the computer 112 is connected to the imaging device by wire or by wireless. The computer 112 is provided with the detection section, calculation section and estimation section as mentioned above.

### —Calculation Section—

The calculation section finds a volume flow rate of the slag flow SF from the images captured by the image capture section. The meaning of “the images” captured by the image capture section is intended to include, when the image capture section captures static images of the slag flow, the static images themselves, and when the image capture section captures a video image of the slag flow, static images extracted from the video image.

The calculation section may use the aforementioned expression (1) to find the volume flow rate Q (m³/s) of the slag flow SF.

A width L (m) is measured by the calculation section from an image capturing the slag flow SF (a static image). More specifically, the width L is a width of the slag flow SF in a static image capturing the slag flow SF, at an arbitrary position in the vertical direction. The arbitrary position may be decided by the calculation section and may be decided by a user of the estimation system 110. The width L is measured by measuring a number of pixels in the horizontal direction in the slag flow SF at the arbitrary position, on the basis of a distance per pixel in the static image, which is calculated geometrically from the magnification of the capturing imaging device 111 and a distance between the imaging device 111 and the slag flow SF.

A cross-sectional area S (m²) of the slag flow SF is found by a similar method to the first exemplary embodiment.

The parameter α is found by a similar method to the first exemplary embodiment.

A flow speed V (m/s) of the slag flow SF is found by a similar method to the first exemplary embodiment.

### —Estimation Section—

The estimation section estimates a slag amount flowing out from the electric furnace 101 on the basis of volume flow rates found by the calculation section.

The estimation section finds a bulk density ρ (kg/m³) of the slag from the aforementioned expression (2) and finds a mass M (kg) of the slag flow from the following expression (3).

$$ρ = ρ L \cdot ( 100 - φ ) / 100 \qquad ( 2 )$$

$$M = ρ \cdot Σ ( Δ t \cdot Q ) \qquad ( 3 )$$

ρ: bulk density of the slag 104 (kg/m³)
ρL: density of uniform liquid phase slag (kg/m³)
φ: gas phase fraction in the slag, calculated from a change in slag thickness between an electrification start time of the electric furnace 101 (a treatment start time) and the time the slag flows out
Δt: interval (s) between image capture times (When static images are captured, the interval between capture times of two static images. When a video image is captured, an interval between capture times of two static images extracted from the video image.)

The gas phase fraction y of the slag is found by the following expression (4).

$$φ = ( {h}_{0} - h ) / {h}_{0} \cdot 100 \qquad ( 4 )$$

h₀: Slag thickness (m) when electrification starts
h: Slag thickness (m) when the width L is measured

The density ρL of uniform liquid phase slag mentioned here may be found from a component composition of the slag 104. The slag thicknesses for the gas phase fraction y may be found from a change in electrification conditions caused by raising or lowering of the electrodes 102, and may be measured directly using a slag measurement probe.

In the estimation system 110 as described above, the slag 104 flowing out from the electric furnace 101 is estimated by image analysis. Conventionally, slag discharge amounts have been estimated by geometric calculations taking account of discharged slag amount (slag discharge amount) regulation caused by the attachment of a fixture to a slag outflow portion, the furnace interior shape and the like. However, these calculations are difficult in continuous operation, and estimation errors are caused by large effects from furnace interior shapes and variations in slag and molten metal. Measurement by a weighing instrument mounted at a slag receiving car or the like is also problematic because of high cost of the weighing instrument itself and the risk of malfunctions due to contact between the weighing instrument and high-temperature molten material (molten slag, molten metal or the like).

By contrast, the estimation system 110 according to the exemplary embodiment may solve all of these problems. That is, a process according to the estimation system 110 of the exemplary embodiment makes continuous operation more feasible than attaching a fixture or the like to a discharge nozzle. In addition, slag discharge amounts from an electric furnace may be estimated with higher precision than when slag discharge amounts are found by geometry or empirical measurements.

An estimation system of the present disclosure has been described above using the estimation system 110, which is an excellent embodiment. However, estimation systems of the present disclosure are not limited by this example.

For example, an estimation system according to the present disclosure may be used for estimation of discharge amounts, slopping amounts (unpredictable overflows of slag containing unprocessed metal from the converter throat) and the like at a converter.

It is sufficient that the estimation system according to the present disclosure is provided with the detection section, image capture section, calculation section and estimation section. Structures of equipment realizing these sections are not particularly limited. In this exemplary embodiment, the detection section, calculation section and estimation section are provided at the same device, but the estimation system of the present disclosure does not require this. The calculation section and estimation section may be provided at separate devices (for example, separate computers) and, for example, the detection section may be provided at the imaging device.

### Electric Furnace Slag Discharge Amount Estimation Method

A slag discharge amount estimation method for an electric furnace according to the present disclosure includes: a detecting step of detecting a slag flow flowing out from the electric furnace; a capturing step of, when the slag flow has been detected, capturing the slag flow; a calculating step of finding a volume flow rate of the slag flow from captured images; and an estimating step of estimating a slag amount flowing out from the electric furnace on the basis of the volume flow rate.

The estimation method of the present disclosure may be implemented by the estimation system of the present disclosure. Configurations of the estimation method of the present disclosure are as described above. Therefore, descriptions thereof are not given here.

### Refining Process in Electric Furnace

A refining process in an electric furnace according to the present disclosure includes adjusting at least one of a type of a refining material to be added into the furnace, an addition amount of the refining material, a voltage, a current and an electrode height on the basis of a slag discharge amount estimated by the estimation system or estimation method of the present disclosure described above. The refining material is a material used for refining a high-temperature molten material. Types of the refining material are not particularly limited. For example, a CaO source such as quicklime or the like can be mentioned.

Because the estimation system or estimation method of the present disclosure may estimate a slag discharge amount precisely, a slag amount remaining in an electric furnace may be estimated precisely. Accordingly, in a refining process at an electric furnace according to the present disclosure, refining of a high-temperature molten material may be carried out suitably by adjusting at least one of a type and addition amount of a refining material to be added into the furnace, a voltage, a current and an electrode length on the basis of a precisely estimated slag discharge amount or remaining slag amount.

For example, when a CaO source is used as the refining material, a situation can be expected in which an estimated slag amount flowing out from the electric furnace is smaller than expected and alkalinity of the high-temperature molten material will be lower than expected with a previously prepared amount of the CaO source. In this situation, there is concern about excessive foaming and the dephosphorizing reaction being insufficient. Therefore, an additional charge of the CaO source is necessary. Thus, a slag composition suitable for refining reactions may be provided by adjusting the addition amount of the refining material on the basis of the precisely estimated slag discharge amount.

Voltage, current and electrode length are also important indicators for arc generation in operations of the electric furnace. To make electrification efficient by lowering electricity consumption, the voltage, current and electrode height must be regulated in accordance with slag amounts. In the present disclosure, a slag amount in a furnace may be identified on the basis of a precisely estimated slag discharge amount. Hence, the voltage, current and electrode height may be adjusted on the basis of that information. Consequently, because electrification may be implemented efficiently, the high-temperature molten metal may be suitably refined.

In the exemplary embodiment described above, the electric furnace 101 is used as an example of a refining vessel, but the present disclosure is not limited thus. For example, a converter, a molten steel ladle and a torpedo wagon (torpedo car) may be used as examples of refining vessels.

### =Test Examples=

Table 2 shows conditions of Test Examples 1 to 10 that were carried out. In Table 2, α, H and Δt are as described above. Table 3 shows slag discharge amounts estimated using an estimation system according to the present disclosure as Examples. Slag discharge amounts estimated in accordance with conventional technology from furnace interior shapes, tilt angles and the like of electric furnaces are shown as Comparative Examples. Estimation errors are found from expression (5) below.

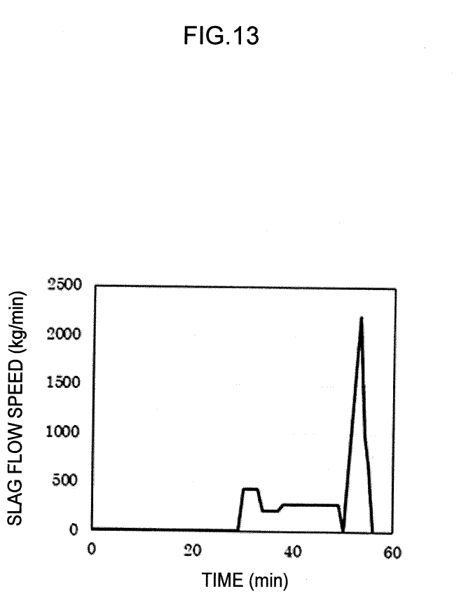

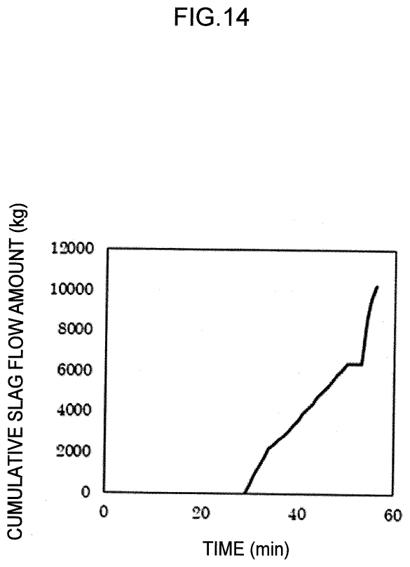

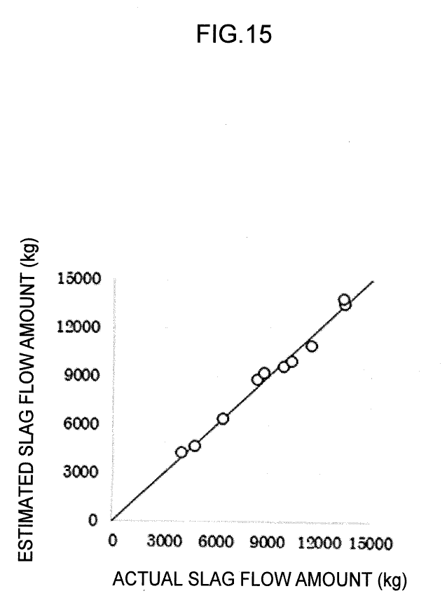

FIG. 13 shows measurement results of mass flow rates (slag flow speeds) in one of Test Examples 1 to 10. FIG. 14 shows measurement results of cumulative slag discharge amounts in one of Test Examples 1 to 10. FIG. 15 depicts results showing a relationship between actual slag flow amounts and estimated slag flow amounts found by the Examples.

TABLE 2

| | | Auxiliary feed | | | |
|---|---|---|---|---|---|
| Test | Molten steel | material charge | | | |
| No. | amount (ton) | amount (ton) | α | H (m) | Δt (s) |
| 1 | 155.2 | 15.2 | 0.046 | 3 | 0.03 |
| 2 | 139.2 | 13.6 | 0.046 | 3 | 0.03 |
| 3 | 150.2 | 14.7 | 0.046 | 3 | 0.03 |
| 4 | 152.2 | 14.9 | 0.046 | 3 | 0.03 |
| 5 | 148.3 | 14.5 | 0.046 | 3 | 0.03 |
| 6 | 160.5 | 15.7 | 0.046 | 3 | 0.03 |
| 7 | 150.5 | 14.7 | 0.046 | 3 | 0.03 |
| 8 | 111.8 | 11.0 | 0.046 | 3 | 0.03 |
| 9 | 119.1 | 11.7 | 0.046 | 3 | 0.03 |
| 10 | 119.1 | 11.7 | 0.046 | 3 | 0.03 |

TABLE 3

| | Actual slag | Example | | Comparative Example | |
|---|---|---|---|---|---|
| Test | discharge | Estimated | Estimation | Estimated | Estimation |
| No. | amount (kg) | amount (kg) | error (%) | amount (kg) | error (%) |
| 1 | 13470 | 13427 | 0.32 | 16267 | 20.8 |
| 2 | 8430 | 8724 | 3.49 | 12554 | 48.9 |
| 3 | 11520 | 10845 | 5.86 | 10468 | 9.1 |
| 4 | 9900 | 9563 | 3.40 | 6648 | 32.8 |
| 5 | 8800 | 9169 | 4.19 | 8724 | 0.9 |
| 6 | 13400 | 13751 | 2.62 | 10759 | 19.7 |
| 7 | 10400 | 9894 | 4.87 | 9535 | 8.3 |
| 8 | 4037 | 4240 | 5.03 | 4922 | 21.9 |
| 9 | 6893 | 6287 | 1.66 | 4997 | 21.8 |
| 10 | 4827 | 4611 | 4.47 | 5577 | 15.5 |

| | |
|---|---|
| Average estimation | Average estimation |
| error: 3.4% | error: 20.0% |

$$Estimation error ( \% ) = \vert ( actual slag discharge amount ) - ( estimated slag discharge amount ) \vert / actual slag discharge amount \times 100 \qquad ( 5 )$$

As shown in Table 3, the Examples estimated slag discharge amounts more precisely than the Comparative Examples. As shown in Table 3 and FIG. 15, estimation errors found from estimated amounts and actual amounts were smaller in the Examples, confirming that slag discharge amounts could be estimated more precisely.

### Third Exemplary Embodiment

Now, a slag discharge amount estimation method according to a third exemplary embodiment is described.

First, a slag discharge amount estimation system (below referred to where appropriate as “the estimation system”) using the converter 20 according to the present exemplary embodiment is described. The estimation system according to the present exemplary embodiment is a system that uses image analysis to estimate a slag discharge amount. More specifically, widths of a slag flow are found from images of a slag flow SF during intermediate slag discharge, and a slag discharge amount (slag discharge mass) is estimated. The estimation system is provided with the imaging device 40 and the computer 42, which is an example of the estimation device. Descriptions of the imaging device 40 are not given for structures that are similar to the first exemplary embodiment, and descriptions of the computer 42 are not given for structures that are similar to the first exemplary embodiment.

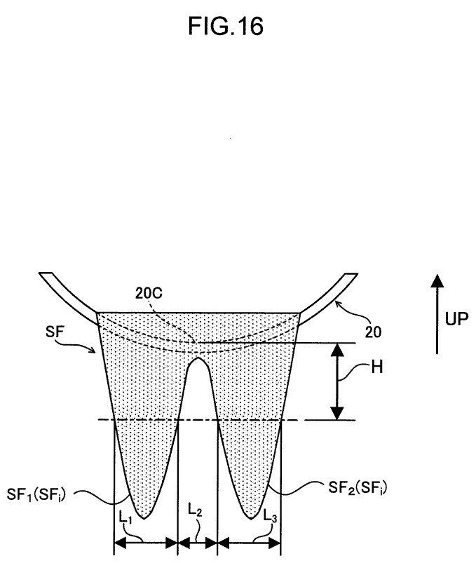

The imaging device 40 has functions for capturing the slag flow SF flowing out from the converter 20. More specifically, as shown in FIG. 1A and FIG. 1B, the imaging device 40 is disposed in front of the converter 20 and captures the slag flow SF flowing out (flowing down) toward the slag pan 22 from the throat 20C of the converter 20 that is tilted during intermediate slag discharge. The meaning of “the imaging device 40 is disposed in front of the converter 20” is intended to include the imaging device 40 being disposed to sandwich the slag pan 22 in plan view (as seen from above) at the opposite side of the slag pan 22 from the side thereof at which the converter 20 is disposed. It is preferable if the imaging device 40 is disposed such that a straight line that passes through a center of the converter 20 and a center of the slag pan 22 in plan view is superposed with an optical axis OA of the imaging device 40. The arrow UP shown in FIG. 1A, FIG. 1B and FIG. 16 indicates the upward direction. In the present exemplary embodiment, one of the imaging device 40 is disposed in front of the converter 20.

One or both of a bandpass filter that selectively transmits a wavelength range in a range from the visible light region to the infrared light region and a light dimming filter that reduces incident light amounts may be attached to the imaging device 40. Because the at least one of a bandpass filter and a light dimming filter that reduces incident light amounts is attached to the imaging device 40 in this way, appearances of halation due to radiant light from the slag flow SF in images captured by the imaging device 40 may be suppressed.

As a bandpass filter to be attached to the imaging device 40, it is preferable to use a bandpass filter that selectively transmits wavelengths of λ±10 nm or less around a wavelength λ selected from a visible light wavelength range from 380 nm to 780 nm. It is even more preferable to use a bandpass filter that selectively transmits wavelengths of λ±10 nm or less around a wavelength λ selected from a visible light wavelength range from 450 nm to 750 nm as a bandpass filter.

As a light dimming filter to be attached to the imaging device 40, it is preferable to use a light dimming filter that reduces the incident light amount to 90% or less. It is even more preferable to use a light dimming filter that reduces the incident light amount to 70% or less as a light dimming filter.

The computer 42 has functions for finding widths of the slag flow SF from captured images and estimating a slag discharge amount. The computer 42 according to the present exemplary embodiment has functions for, when the slag flow SF is divided into plural flows in the images captured by the imaging device 40, finding a width Lᵢ of each slag flow division SFᵢ and using a total Lₛᵤₘ of the widths Lᵢ that are found to estimate the slag discharge amount.

As illustrated in FIG. 9, image information of the slag flow SF captured by the imaging device 40 is successively sent to the computer 42. The computer 42 performs image analysis of the received image information and finds widths of the slag flow. When the image information sent from the imaging device 40 is image information of static images, the computer 42 performs image analysis of the static images. Alternatively, when the image information sent from the imaging device 40 is image information of a video image, static images are extracted from the video image at predetermined intervals (for example, 1 s intervals) and image analysis is performed on each of the extracted static images. With a view to improving estimation precision of the slag flow SF, the computer 42 may, for example, cause the imaging device 40 to capture the static images at a rate of 10 or more per second and perform image analysis of the captured static images, or may extract 10 or more static images per second from a video image captured by the imaging device 40 and perform image analysis of the extracted static images.

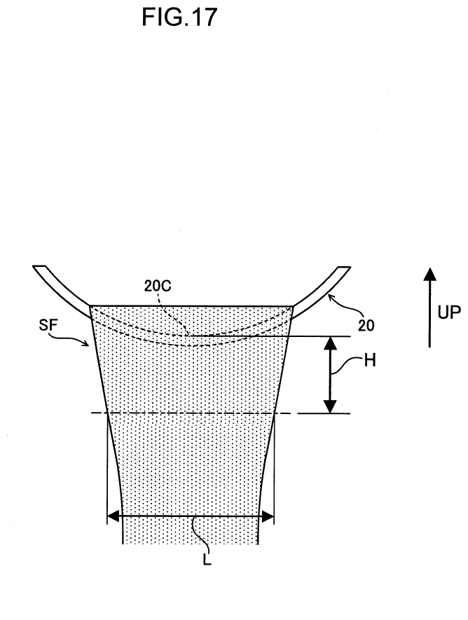

In image analysis of a static image by the computer 42, firstly the static image is binarized. Then, a length of a high-brightness portion in an analysis region that is specified beforehand is measured to serve as an apparent length of the slag flow SF. As shown in FIG. 17, the length of the high-brightness portion of the slag flow SF corresponds to the width of the slag flow SF.

The computer 42 also determines whether the slag flow SF in the captured image is divided into plural flows. More specifically, the computer 42 determines that the slag flow SF is divided into plural flows when plural high-brightness portions are present in the captured image, spaced apart in the horizontal direction. The determination as to whether the slag flow SF is divided into plural flows may be conducted each time an image is analyzed or may be carried out periodically.

When the computer 42 determines that the slag flow SF is divided into plural flows in a captured image, the computer 42 finds widths Lᵢ of the slag flow divisions SFᵢ and finds a total Lₛᵤₘ of the widths Lᵢ that are found. In the example shown in FIG. 16, the slag flow SF is divided in the horizontal direction into two slag flow divisions SFᵢ. Of the two slag flow divisions SFᵢ, one slag flow division is indicated with the reference symbol SFᵢ, and the other slag flow division is indicated with the reference symbol SF₂. Therefore, in the example shown in FIG. 16, the total Lₛᵤₘ is found by Lₛᵤₘ=width Lᵢ+width L₃, in which Lᵢ is the width of the first slag flow division SFᵢ and L₃ is the width of the second slag flow division SF₂. L₂ is the width of a region dividing the slag flow SF, being the width of a region in which slag is not flowing.

The computer 42 finds a flow speed V (m/s) from the captured images. The computer 42 may set an assumed freefall rate of the slag flow SF of (2gH)^{0.5} as the flow speed V (m/s) of the slag flow SF at the position of measurement of the width Lᵢ and the width L₂, or the computer 42 may find a movement distance of the slag flow SF by pattern matching from two or more of the images, and find the flow speed V (m/s) by dividing the movement distance of the slag flow SF by a difference (s) between the capture times of the images providing the movement distance. When the speed V (m/s) is to be assumed to be the freefall rate of the slag flow SF, the computer 42 finds a distance H (m) from the position of measurement of the widths Lᵢ to the flow start position from the throat 20C of the slag flow SF by image analysis of the captured static images. Because the converter 20 is rotated about an axis, the position of flowing out from the throat 20C may be found by finding the throat 20C (the slag flowing out position) geometrically from a tilt angle.

The computer 42 finds a slag amount M from the following expression (6).

$$M = ρ \cdot Δ t \cdot \sum \{ α \cdot π \cdot {( \sum {L}_{i} )}^{2} \cdot {V}_{1} \} \qquad ( 6 )$$

M: slag discharge mass (kg)
ρ: bulk density of the slag (kg/m³)
Δt: time interval between images (s)
α: parameter for correcting the cross-sectional shape of the slag flow
Lᵢ width of slag flow division (m)
V₁: average value of flow speeds of the slag flow divisions, flow speed of one of the slag flow divisions, or a flow speed of each slag flow division

The bulk density ρ of the slag is found in the same way as in the first exemplary embodiment.

In the example in FIG. 16, the slag flow SF is divided into the two slag flow divisions SFᵢ and SF₂. Therefore, (ΣLᵢ)² in expression (6) is found in the form (L₁+L₃)².

When the slag flow SF is not divided into plural flows in a captured image, as shown in FIG. 17, the computer 42 finds the width L of the slag flow SF. The computer 42 finds the flow speed V (m/s) from the captured images. Then the computer 42 finds the slag discharge amount M from the following expression (8).

$$M = ρ \cdot Δ t \cdot \sum α π {L}^{2} \cdot V \qquad ( 8 )$$

M: slag discharge mass (kg)
ρ: bulk density of the slag (kg/m³)
Δt: time interval between images (s)
α: parameter for correcting the cross-sectional shape of the slag flow
L: width of the slag flow (m)
V: flow speed of the slag flow (m/s).

Now, a slag discharge amount estimation method using the converter 20 according to the present exemplary embodiment is described. The slag discharge amount estimation method according to the present exemplary embodiment uses image analysis to estimate a slag discharge amount. More specifically, widths of a slag flow SF during intermediate slag discharge are found from images of the slag flow, and a slag discharge amount (slag discharge mass) is estimated. Even more specifically, the slag discharge amount estimation method captures the slag flow SF flowing out from the converter 20, finds the width(s) of the slag flow SF from the captured images, and estimates the slag discharge amount. When the slag flow SF is divided into plural flows in the captured images, the estimation method finds the width Lᵢ of each slag flow division and uses the total Lₛᵤₘ of the widths Lᵢ that are found to estimate the slag discharge amount.

First, the slag flow SF flowing out from the throat 20C of the converter 20 is captured. More specifically, as illustrated in FIG. 1A and FIG. 1B, the imaging device 40 captures the slag flow SF flowing out (flowing down) toward the slag pan 22 from the throat 20C of the converter 20 that is tilted for intermediate slag discharge.

Then, the computer 42 determines whether the slag flow SF is divided in the captured images. When the flow is divided, the computer 42 uses the above expression (6) to estimate the slag discharge amount, and when the flow is not divided, the computer 42 uses the above expression (8) to estimate the slag discharge amount. The determination as to whether the slag flow SF is divided is conducted, for example, for each static image or periodically. That is, the slag discharge amount estimation is carried out repeatedly in accordance with repeated determinations as to whether the slag flow SF is divided. Below, a situation in which the slag flow SF is determined to be divided is described.

Next, a width of the slag flow SF is found from an image captured by the imaging device 40. More specifically, image information in which the slag flow SF is captured by the imaging device 40 is received by the computer 42, and the computer 42 performs image analysis to find the width of the slag flow SF. In this situation, because the slag flow SF is determined to be divided into plural flows, the computer 42 finds the width Lᵢ of each slag flow division SFᵢ, and uses the total Lₛᵤₘ of the widths Lᵢ that are found as the width of the slag flow SF. In the example shown in FIG. 9, the total Lₛᵤₘ is found from the width Lᵢ of the first slag flow SF₁ and the width L₃ of the second slag flow SF₂.

Next, the flow speed V (m/s) is found from the captured images. More specifically, the computer 42 may set an assumed freefall rate of the slag flow SF of (2gH)^{0.5} as the flow speed V (m/s) of the slag flow SF at the position of measurement of the width of the slag flow SF, or the computer 42 may find a movement distance of the slag flow SF by pattern matching from two or more of the images, and find the flow speed V (m/s) by dividing the movement distance of the slag flow SF by a difference (s) between the capture times of the images providing the movement distance.

Then, the computer 42 uses the above expression (6) to find the slag discharge amount. In this way, a slag discharge amount from the converter 20 is estimated.

Now, operational effects of the present exemplary embodiment are described.

In the present exemplary embodiment, when the slag flow SF is divided into plural flows in an image captured by the imaging device 40, the width Lᵢ of each slag flow division SFᵢ is found, and the total Lₛᵤₘ of the widths Lᵢ that are found is used to estimate the slag discharge amount. Therefore, in the present exemplary embodiment, in contrast to a structure in which the width of the slag flow SF is found to be width L₁+width L₂+width L₃ shown in FIG. 16, the width L is found to be width L₁+width L₃, and therefore the slag discharge amount may be estimated with higher precision. That is, according to the present exemplary embodiment, even when the slag flow SF is divided into plural flows, the slag discharge amount may be estimated precisely.

When one or both of a bandpass filter and a light dimming filter that reduces incident light amounts is attached to the imaging device 40, appearances of halation due to radiant light from the slag flow SF in images captured by the imaging device 40 may be suppressed. Because occurrences of halation are accordingly suppressed, widths of the slag flow SF may be found from the images captured by the imaging device 40 with higher precision. In addition, detection of when the slag flow SF is divided is easier and slag discharge amounts may be estimated precisely.

In the exemplary embodiment described above, when the slag flow SF is divided into plural flows in an image captured by the imaging device 40, the widths Lᵢ of the slag flow divisions SFᵢ are found and the total Lₛᵤₘ of the widths Lᵢ that are found is used to estimate the slag discharge amount, but the present disclosure is not limited thus. When the slag flow SF is divided into plural flows in images captured by the imaging device 40 as illustrated in FIG. 16, the widths Lᵢ of the slag flow divisions SFᵢ may be found, the widths Lᵢ that are found may be used to estimate a slag discharge amount Mᵢ for each slag flow division SFᵢ, and the total slag discharge amount M may be estimated from the estimated slag discharge amounts Mᵢ. The total slag discharge amount M is found by the following expression (7).

$$M = \sum {M}_{i} = ρ \cdot Δ t \cdot \sum ( α \cdot π {L}_{i}^{2} \cdot {V}_{2} ) \qquad ( 7 )$$

M: slag discharge mass (kg)
Mᵢ: slag discharge mass of a slag flow division (kg)
ρ: bulk density of the slag (kg/m³)
Δt: time interval between images (s)
α: parameter for correcting the cross-sectional shape of the slag flow
Lᵢ: width of slag flow division (m)
V₂: average value of flow speeds of the slag flow divisions, flow speed of one of the slag flow divisions, or a flow speed of each slag flow division

In the example in FIG. 16, because the slag flow SF is divided into the two slag flow divisions SF₁ and SF₂, Lᵢ² in expression (7) is found in the form L₁²+L₃².

For the flow speed V₂, finding the flow speed of each slag flow division and employing these flow speeds in expression (7) is most preferable. However, finding the flow speed of one of the slag flow divisions and employing that flow speed as the flow speed of all slag flow divisions in expression (7) is acceptable given that, because the position at which the widths of the slag flow are measured is the same for all the slag flow divisions, flow speeds are almost identical regardless of slag proportions. This may reduce a burden on the computer 42 of processing to find the flow speed.

The imaging device 40 may monitor the imaging region and, when a material with high brightness is detected in the imaging region, record states in the imaging region as images, that is, start capturing. Distinguishing a material with high brightness in the imaging region may be implemented at the computer 42 and may be implemented at an image processing section embedded in the imaging device 40. Alternatively, the imaging device 40 may start recording in response to a command from the computer 42 when tilting of the converter 20 reaches a predetermined angle.

In the exemplary embodiment described above, the converter 20 is used as an example of a refining vessel, but the present disclosure is not limited thus. For example, an electric furnace, a molten steel ladle and a torpedo wagon (torpedo car) may be used as examples of the refining vessel.

### —Test Examples—

Now, results obtained with the technology of the present disclosure are verified.

Table 4 shows average estimation errors of Examples employing the technology of the present disclosure and an average estimation error of a Comparative Example in which the technology of the present disclosure is not employed.

In the Examples and Comparative Example, 30 still images per second of states of a slag flow at a converter were captured with a camera (imaging device), these still images were analyzed and slag discharge amounts were estimated.

In the Examples, slag discharge amounts were found using the projection method according to the above expression (6) and the projection method using the above expression (7). In the Comparative Example, slag discharge amounts were estimated in accordance with a conventional technology under conditions in which division of the slag flow could not be detected. Other measurement conditions were same between the Examples and the Comparative Example. Estimation errors were found from the above expression (5).

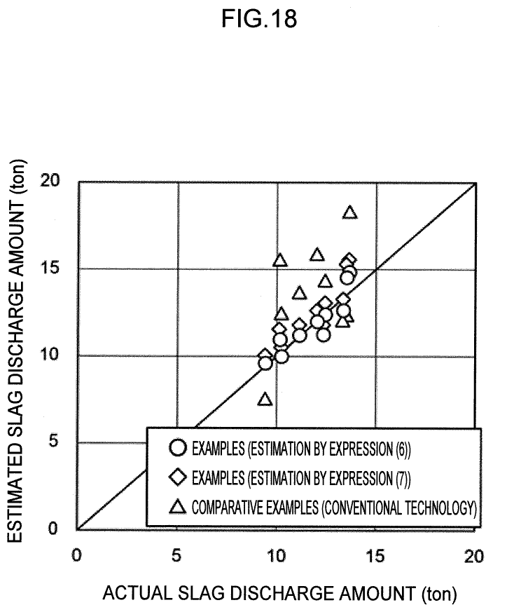

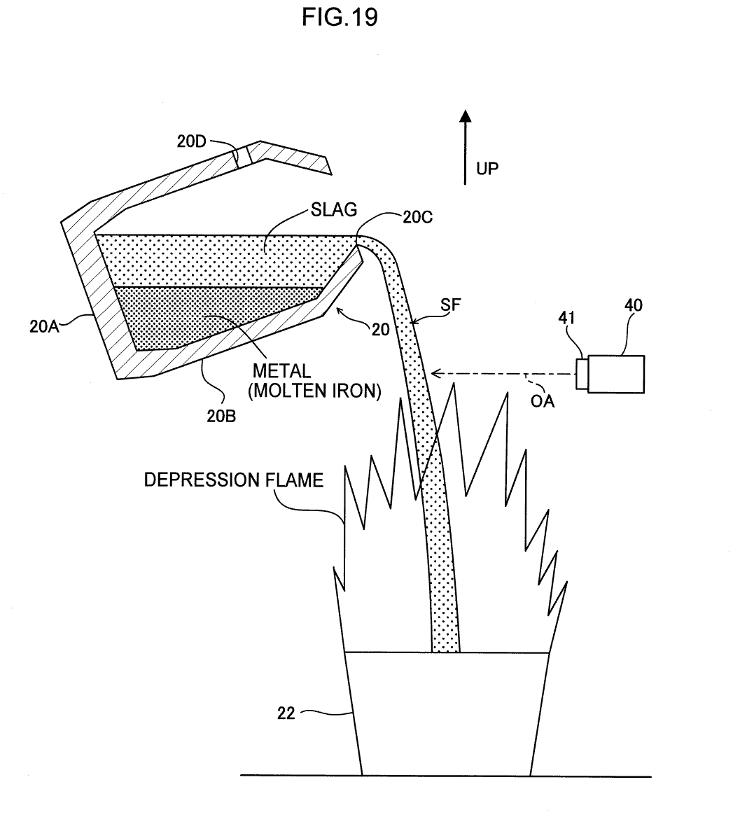

FIG. 18 depicts results showing relationships between actual slag discharge amounts (measured by a weighing instrument) in the Examples and the Comparative Example and estimated slag discharge amounts found by the Examples and the Comparative Example.

TABLE 4

| | Average estimation |
|---|---|
| | error (%) |
| Example (estimation by expression (6)) | 7.91 |
| Example (estimation by expression (7)) | 4.98 |
| Comparative Example (conventional technology) | 16.5 |

As shown in Table 4, the average estimation errors in the Examples were 4.98% and 7.91%, while the average estimation error in the Comparative Example was 16.5%. That is, the Examples had smaller average estimation errors than the Comparative Example, and therefore estimated slag discharge amounts more precisely. Comparing the Examples with one another, it can be seen that the results of estimation using expression (7) could estimate slag discharge amounts more precisely than the results estimated using expression (6). Thus, it is confirmed that slag discharge amounts may be estimated more precisely than with conventional technology, whether the technology relating to expression (6) or the technology relating to expression (7) of the present disclosure is utilized.

### Fourth Exemplary Embodiment

Now, a slag discharge amount estimation method according to a fourth exemplary embodiment is described.

First, a slag discharge amount estimation system (below referred to where appropriate as “the estimation system”) using the converter 20 according to the present exemplary embodiment is described. The estimation system according to the present exemplary embodiment is a system that uses image analysis to estimate a slag discharge amount. More specifically, widths of a slag flow are found from images of a slag flow SF during intermediate slag discharge, and a slag discharge amount (slag discharge mass) is estimated. The estimation system is provided with the imaging device 40 and the computer 42, which is an example of the estimation device. Descriptions of the imaging device 40 are not given for structures that are similar to the first exemplary embodiment, and descriptions of the computer 42 are not given for structures that are similar to the first exemplary embodiment.

The imaging device 40 limits incident light amounts so as to moderate brightness of the slag flow SF that is high-brightness material in the captured images. That is, incident light amounts on the imaging device 40 are limited in order to suppress appearances of halation due to radiant light from the slag flow SF in the captured images. In the present exemplary embodiment, a limiting filter 41 for limiting incident light amounts is attached to the imaging device 40. The limiting filter 41 differs depending on measurement conditions, but it is preferable to use a limiting filter that reduces incident light amounts to 90% or less, and even more preferable to use a limiting filter that reduces incident light amounts to 70% or less.

The computer 42 finds the slag discharge amount from the aforementioned expression (8).

Now, the slag discharge amount estimation method using the converter 20 according to the present exemplary embodiment is described. The slag discharge amount estimation method according to the present exemplary embodiment uses image analysis to estimate a slag discharge amount. More specifically, widths of a slag flow SF during intermediate slag discharge are found from images of the slag flow, and a slag discharge amount (slag discharge mass) is estimated. Even more specifically, the slag discharge amount estimation method captures the slag flow SF flowing out from the converter 20, finds widths of the slag flow SF from the captured images, and estimates the slag discharge amount. Incident light amounts on the imaging device 40 capturing the slag flow SF are limited, the slag flow SF and flames that occur during the discharge (referred to as depression flames) are distinguished by brightness differences in the captured images between the slag flow SF and the flames, and the width of the slag flow SF is found to estimate the slag discharge amount.

First, the slag flow SF flowing out from the throat 20C of the converter 20 is captured. More specifically, as illustrated in FIG. 18, the imaging device 40 captures the slag flow SF flowing out (flowing down) toward the slag pan 22 from the throat 20C of the converter 20 that is tilted for intermediate slag discharge. The imaging device 40 may be used to capture a region at the upstream side of the slag flow SF. The meaning of “a region at the upstream side of the slag flow SF” is intended to include a region that is at an upper side relative to a position halfway in the height direction from a position where the slag flows out from the throat 20C to the slag pan 22. The region at the upstream side of the slag flow SF is captured by the imaging device 40 being disposed such that the optical axis OA of the imaging device 40 is directed at the region at the upstream side of the slag flow SF.

Next, the width of the slag flow SF is found from an image captured by the imaging device 40. More specifically, image information in which the slag flow SF is captured by the imaging device 40 is received by the computer 42, and the computer 42 performs image analysis to find the width of the slag flow SF. The width L of the slag flow SF may be found using the region at the upstream side in the image capturing the slag flow SF. The meaning of “region at the upstream side in the image capturing the slag flow SF” is intended to include a region at the upstream side relative to the middle of the length of the slag flow SF in the vertical direction in the captured image.

Next, the flow speed V (m/s) is found from the captured images. More specifically, the computer 42 may set an assumed freefall rate of the slag flow SF of (2gH)^{0.5} as the flow speed V (m/s) of the slag flow SF at the position of measurement of the width of the slag flow SF, or the computer 42 may find a movement distance of the slag flow SF by pattern matching from two or more of the images, and find the flow speed V (m/s) by dividing the movement distance of the slag flow SF by a difference (s) between the capture times of the images providing the movement distance.

Then, the computer 42 uses the above expression (8) to find the slag discharge amount. In this way, the slag discharge amount from the converter 20 is estimated.

Now, operation of the present exemplary embodiment is described.

A depression flame (flames) that is produced from the slag pan 22 during a discharge causes large errors in measurements of the width L of the slag flow SF in image analysis of images capturing the slag flow SF. Therefore, effects of the depression flame must be considered. The present inventors have posited that there are differences in emissivity by wavelength between slag and depression flames, because of differences in the materials emitting light. More specifically, while the slag flow SF is slag (molten oxides), depression flames are formed from organic materials included in a depressant, and the two have different spectral emissivities at respective wavelengths. Accordingly, we conducted diligent studies into differences in brightness between the slag flow SF and depression flames at the same observation wavelengths, and into the presence of singular wavelengths that can be clearly observed only in the slag flow SF. As a result, we found that when incident light amounts on the imaging device 40 in the wavelength range of visible light are limited to an extent such that brightness of the slag flow SF in a captured image is not moderated, brightness of the slag flow SF in the captured image is markedly greater than the depression flame. Therefore, even when a depression flame is produced during a discharge, continuous measurements of widths L of the slag flow SF should be possible. The present inventors have proposed an estimation method of limiting incident light amounts on the imaging device 40 capturing the slag flow SF, distinguishing the slag flow SF from a depression flame produced during the discharge in captured images by brightness differences between the slag flow SF and the depression flame, finding widths L of the slag flow SF, and using the widths L that are found to estimate a slag discharge amount. In this estimation method, because incident light amounts on the imaging device 40 capturing the slag flow SF are limited, even when flames are produced from the slag pan 22 due to charging of a depressant, the slag flow SF and the depression flame may be distinguished more clearly than in, for example, a configuration in which incident light amounts on the imaging device 40 are not limited. Therefore, even in a state in which a depression flame is produced from the slag pan 22, widths L of the slag flow SF may be found precisely. Improving the measurement precision of the widths L of the slag flow SF enables more precise estimation of slag discharge amounts.

In the present exemplary embodiment, the slag flow SF is captured by the imaging device 40 to which the limiting filter 41 is attached. That is, a multiplicity of the limiting filter 41 that limit incident light amounts in different amounts may be prepared, and the limiting filter 41 being used may be replaced in accordance with imaging conditions. Thus, the slag flow SF and a depression flame may be distinguished without a threshold setting of the computer 42 being changed.

When a limiting filter that dims incident light amounts to 90% or less is used as the limiting filter 41, halation at the slag flow SF in the images captured by the imaging device 40 may be suppressed effectively. Using a limiting filter that dims incident light amounts to 70% or less as the limiting filter 41 is even more preferable.

In the present exemplary embodiment, because the region at the upstream side of the slag flow SF is captured by the imaging device 40, effects from depression flames on the captured images may be reduced compared to when, for example, a region at the downstream side of the slag flow SF is captured. Therefore, even in a state in which a depression flame is produced from the slag pan 22, the slag flow SF and the depression flame may be easily distinguished and widths L of the slag flow SF may be found precisely.

In the present exemplary embodiment, the region at the upstream side of images capturing the slag flow SF is used for finding widths L of the slag flow SF. Therefore, effects from depression flames on the images of the slag flow SF may be reduced compared to when, for example, a region at the downstream side in the images capturing the slag flow SF is used for finding widths L of the slag flow SF. Therefore, even in a state in which depression flames are rising from the slag pan 22, the slag flow SF and the depression flames may be easily distinguished and widths L of the slag flow SF may be found precisely. Therefore, even in a state in which a depression flame is produced from the slag pan 22, the slag flow SF and the depression flame may be easily distinguished and widths L of the slag flow SF may be found precisely.

The imaging device 40 may, when a material with high brightness is distinguished in the imaging region, record conditions in the imaging region as images, that is, start capturing. Distinguishing a material with high brightness in the imaging region may be implemented at the computer 42 and may be implemented at an image processing section embedded in the imaging device 40. Alternatively, the imaging device 40 may start recording in response to a command from the computer 42 when tilting of the converter 20 reaches a predetermined angle.

In the exemplary embodiment described above, incident light amounts on the imaging device 40 are limited, but the present disclosure is not limited thus. For example, wavelengths of light incident on the imaging device 40 may be limited. More specifically, limiting such that incident light has wavelengths of between 3.0 μm and 4.0 μm or of at least 5.0 μm is preferable. While the slag flow SF is slag (molten oxides), a depression flame is formed from organic materials included in a depressant or the like, and the two have different spectral emissivities at respective wavelengths. Consequently, it is thought that brightnesses of the slag flow SF and depression flames at the same observation wavelengths differ and that there are singular wavelengths that can be clearly observed only in the slag flow SF. Accordingly, the present inventors have proposed the method of distinctly capturing just the slag flow SF by limiting wavelengths of incident light on the imaging device 40. More specifically, the slag flow SF alone may be distinctly captured by setting the wavelengths of incident light on the imaging device 40 to a range of between 3.0 μm and 4.0 μm or of at least 5.0 μm. The wavelength range of incident light on the imaging device 40 is specified as described above because light emission of depression flames is mainly due to dust, which is fine iron powder, the emissivity of iron tends to be lower at longer wavelengths, and the absorptivities of water in the air, carbon dioxide generated during flame production and the like are relatively small. When the slag flow SF is captured with this wavelength range, the slag flow SF alone may be captured with a depression flame being barely apparent in the captured images. Thus, even when a depression flame occurs during a discharge, widths L of the slag flow SF may be continuously measured. Limiting of wavelengths of incident light on the imaging device 40 may also be implemented by attaching a bandpass filter to the imaging device 40.

Both the limiting filter 41 and a bandpass filter may be attached to the imaging device 40. Thus, widths L of the slag flow SF may be found even more precisely.

In the exemplary embodiment described above, the converter 20 is used as an example of a refining vessel, but the present disclosure is not limited thus. For example, an electric furnace, a molten steel ladle and a torpedo wagon (torpedo car) may be used as examples of the refining vessel.

### —Test Examples—

Now, results obtained with the technology of the present disclosure are verified.

Table 5 shows an average estimation error of an Example employing the technology of the present disclosure, an average estimation error of a Comparative Example in which the technology of the present disclosure is not employed, and an average estimation error of a Reference Example.

In the Example, 30 still images per second of states of slag flow at a converter were captured with a camera (imaging device) in a condition in which incident light amounts on the imaging device were limited to 70%, and these still images were analyzed to estimate slag discharge amounts. The Reference Example used widths of a slag flow acquired by simulation of a condition in which wavelengths of incident light on the imaging device were limited to 5.0 μm to estimate slag discharge amounts. When a depression flame was being produced, the slag flow was manually identified and the width measured, and the slag discharge amount was estimated by expression (8). The Comparative Example employed a conventional technology, estimating a discharged slag amount (slag discharge amount) from measured values of slag discharge flow rates according to changes in tilting angle of a furnace that had been measured beforehand.

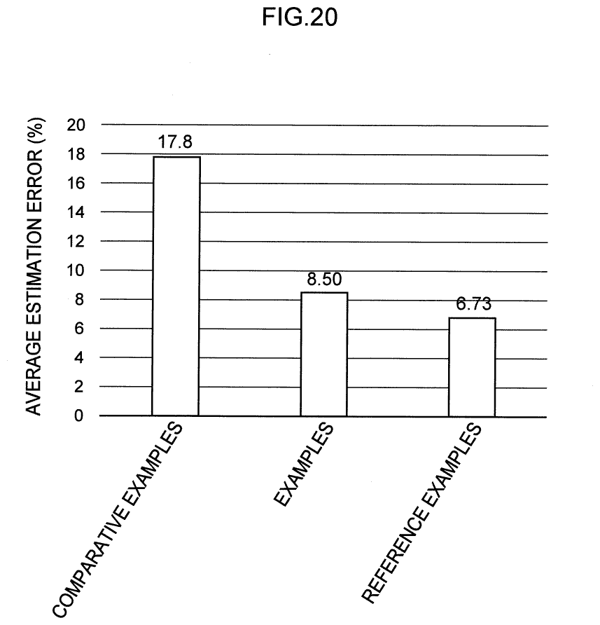

FIG. 20 is a graph showing a comparison of average estimation errors in ten charges of slag discharge amount estimation of the Comparative Example, Example and Reference Example. The estimation errors were found from the aforementioned expression (5).

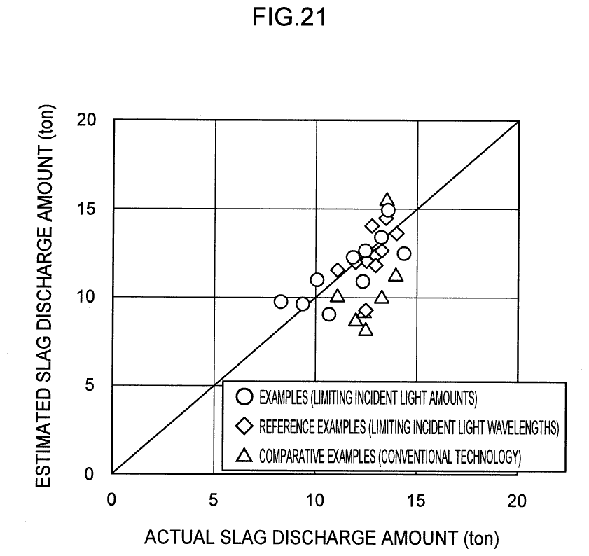

FIG. 21 depicts results showing a relationship between actual slag discharge amounts (measured by a weighing instrument) in the Example and the Comparative Example and estimated slag discharge amounts found by the Example and the Comparative Example. The Reference Example gives results of using the simulation.

TABLE 5

| | Average estimation |
|---|---|
| | error (%) |
| Example (limiting incident light amounts | 8.50 |
| and estimating slag discharge amounts) | |
| Reference Example (limiting incident | 6.73 |
| light wavelengths and estimating slag | |
| discharge amounts) | |
| Comparative Example (estimating slag | 17.8 |
| discharge amounts from converter tilt | |
| angles) | |

As shown in Table 5, FIG. 20 and FIG. 21, the average estimation error in the Example was 8.50%, while the average estimation error in the Comparative Example was 17.8%. The average estimation error in the Reference Example was 6.73%. Thus, it is confirmed that when the technology of the present disclosure is used, slag discharge amounts may be estimated more precisely than with conventional technology.

### Fifth Exemplary Embodiment

Now, a slag discharge amount estimation method according to a fifth exemplary embodiment is described.

The slag discharge amount estimation method according to the fifth exemplary embodiment estimates a discharge amount of slag flowing out from a refining vessel by analyzing images of the slag flow. The refining vessel is a vessel for refining iron in a converter, an electric furnace or the like. The slag is produced by the refining of the iron and is discharged from the refining vessel as appropriate. Ordinarily, the slag is discharged through a slag outlet of the refining vessel, and is collected in a slag collection vessel such as a slag pan or the like disposed below the outlet. In the present description, the meaning of the term “slag outlet” is intended to include a member with the function of discharging the slag from the refining vessel and to include typical slag outlets and other throats. The slag discharge amount estimation method according to the present exemplary embodiment captures a slag flow discharged from the above-mentioned slag outlet and analyzes the captured images to estimate the slag discharge amount. The slag discharge amount estimation method according to the present exemplary embodiment is described below.

First, a slag discharge amount estimation system according to the present exemplary embodiment is described. This estimation system includes a detection section that detects a slag flow of slag flowing out from a refining vessel, an image capture section that captures the slag flow, a measurement section that measures a width L₁ of the slag flow in a captured still image, a recording section that records changes over time of the measured widths L₁ of the slag flow, a determination section, a projection section and an estimation section. The determination section determines that periods in which the width L₁ of the slag flow in the changes over time of the width L₁ of the slag flow exceeds a predetermined threshold Lₘₐₓ are duration of flame/smoke generation in which at least one of flames and smoke is produced, and determines that periods in which the width L₁ of the slag flow is not more than the predetermined threshold Lₘₐₓ are flame/smoke non-production periods in which neither flames nor smoke is produced. The projection section uses widths L₁ of the slag flow just before the start of a duration of flame/smoke generation or just before the start and just after the end of a duration of flame/smoke generation to project widths L₂ of the slag flow in the duration of flame/smoke generation. The estimation section estimates a slag discharge amount with the aforementioned expression (8). When estimating a slag discharge amount in a duration of flame/smoke generation, the estimation section uses a width L₂ of the slag flow projected by the projection section as a width L of the slag flow in expression (8). When estimating a slag discharge amount in a flame/smoke non-production period, the estimation section uses the width L₁ of the slag flow computed by the measurement section in the flame/smoke non-production period or a moving average Lₐᵥₑ of the widths L₁ of the slag flow in the flame/smoke non-production period.

The slag discharge amount estimation system provided with the structures described above may be realized by, for example, a system including an imaging device and a computer. The imaging device is not particularly limited as long as it can capture a slag flow. For example, imaging devices such as CMOS cameras and the like can be mentioned. For the imaging device to capture a slag flow suitably, the imaging device should be disposed as near as possible in front of the slag outlet of the refining vessel. It is sufficient for the computer to have a similar structure to an ordinary computer. To acquire image data from the imaging device, the computer is connected to the imaging device by wire or by wireless. The imaging device is provided with the image capture section, and the computer is provided with the detection section, measurement section, recording section, determination section, projection section and estimation section. These structures of the slag discharge amount estimation system according to the present exemplary embodiment are described below.

### =Detection Section=

The detection section detects a slag flow flowing out from the refining vessel. Detection of the slag flow may be implemented by monitoring at least a region at which the slag flows out from the slag outlet of the refining vessel (region X). While detecting the slag flow, the detection section may utilize an optical filter or the like to block light from lighting and the like.

The meaning of “region at which the slag flows out from the slag outlet of the refining vessel (region X)” is intended to include a region in which the slag flow can be detected (a region that the detection section can detect) when the slag flows out from the slag outlet of the refining vessel. A range of the region X in the horizontal direction encompasses widths in which the slag may flow out from the slag outlet, and a range of the region X in the vertical direction includes at least a portion of a range between a lower end of the slag outlet and an upper end of the collection vessel. The meaning of “widths in which the slag may flow out” is intended to encompass a length in the horizontal direction of the slag flow to be estimated when the slag flows out from the refining vessel. Estimated values of width of slag flows may be obtained experimentally or by simulation.

With a view to preventing misdetection of a slag flow, the horizontal direction range of the region X should be at least the width of the slag flow (the width in which the slag may flow out) and not more than 1500% of the width of the slag flow. Similarly with a view to preventing misdetection of the slag flow, the vertical direction range of the region X should be at least 10% of the length between the slag outlet and the upper end of the collection vessel and not more than 500% of this length.

Detection of a slag flow may be implemented by detecting high-brightness material appearing in the region X. That is, the detection section measures brightness values in the region X. As brightness values, the detection section employs, for example, brightness values expressed in 256 gradations (0 to 255).

It is sufficient that the high-brightness material has brightness values higher than the background, but when a difference in the brightness values between the high-brightness material and the background is small, it may not be possible to suitably detect the slag flow. Accordingly, with a view to detecting the slag flow easily, the detection section may determine that a high-brightness material with brightness values at least 30 higher than the background is the slag flow. With a view to raising detection precision further, the detection section may determine that a high-brightness material with brightness values at least 50 higher than the background is the slag flow.

With a view to preventing misdetections, the high-brightness material may be determined to be the slag flow when the area of the high-brightness material is at least 0.1% of the total area of the region X. With a view to further preventing misdetections, the high-brightness material may be determined to be the slag flow when the area of the high-brightness material is at least 0.5% of the total area of the region X.

### =Image Capture Section=

The image capture section captures the slag flow when the detection section has detected the slag flow. Captured images are sent to the computer (the measurement section). A number of images to be sent is not particularly limited, but should be at least two.

A format of images of the slag flow from the image capture section may be static images and may be a video image. When static images are captured, the images are captured at a rate of at least one per second. With a view to improving slag discharge amount estimation precision, the static images may be captured at a rate of 10 or more per second. When a video image is captured, static images are extracted from the captured video image at a rate of at least one per second. With a view to improving slag discharge amount estimation precision, the static images may be extracted from the captured video image at a rate of 10 or more per second.

### =Measurement Section=

The measurement section measures a width L₁ of the slag flow from a static image captured by the image capture section. The meaning of “static images” is intended to include, when the image capture section captures static images of the slag flow, the static images themselves, and when the image capture section captures a video image of the slag flow, static images extracted from the video image.

The width L₁ (m) of the slag flow is found from the static image. More specifically, the width L₁ of the slag flow is measured at an arbitrary position in the vertical direction in the static image capturing the slag flow. The arbitrary position may be decided by the measurement section and may be decided by a user of the slag flow estimation system. The width L₁ of the slag flow is measured by measuring a number of pixels in the horizontal direction in the slag flow, on the basis of a distance per pixel in the static image, which is calculated geometrically from the magnification of the capturing imaging device and a distance between the imaging device and the slag flow. When the slag flow is divided, a total of widths of the divided slag flows is used as the width L₁ of the slag flow.

### =Recording Section=

The recording section records changes over time in the width L₁ of the slag flow measured by the measurement section. Ordinarily, the recording section records changes over time in the width of the slag flow until the detection section can no longer detect the slag flow.

### =Determination Section=

The determination section determines that a period in which the width L₁ of the slag flow in the changes over time of the width L₁ of the slag flow recorded by the recording section exceeds the predetermined threshold Lₘₐₓ is a duration of flame/smoke generation in which at least one of flames and smoke is produced, and determines that a period in which the width L₁ of the slag flow is less than the predetermined threshold Lₘₐₓ is a flame/smoke non-production period in which neither of flames and smoke is produced.

Large amounts of foam are produced (foaming) in the slag collected in the slag collection vessel. Accordingly, an anti-foaming agent (a depressant) may be charged into the slag. However, when an anti-foaming agent is charged, sometimes one or both of flames and smoke is produced from the slag. When at least one of flames and smoke is produced from the slag, the at least one of flames and smoke may intrude into the static images captured by the image capture section. As a result, measurement precision of the width of the slag flow by the measurement section may decline. More specifically, the high-brightness material has higher brightness values than both flames and smoke (brightness values of smoke are lower than flames and than slag in the slag flow, but higher than the background). Therefore, when the at least one of flames and smoke intrudes into the static images, widths of the slag flow measured by the measurement section can be expected to be higher than the actual width of the slag flow.

Thus, when one or both of flames and smoke is produced, measurement precision of the widths L₁ of the slag flow by the measurement section declines, as a result of which slag discharge amount estimation precision declines. Accordingly, this exemplary embodiment determines from the widths L₁ of the slag flow whether or not at least one of flames and smoke is being produced.

Whether or not at least one of flames and smoke is being produced is determined by determining whether or not the widths L₁ of the slag flow are greater than a predetermined threshold Lₘₐₓ. When the widths L₁ of the slag flow exceed the predetermined threshold Lₘₐₓ, the determination section determines that flames or smoke are being produced, and treats a period in which the widths L₁ exceed the predetermined threshold Lₘₐₓ as a duration of flame/smoke generation. When the widths L₁ of the slag flow are not more than the predetermined threshold Lₘₐₓ, the determination section determines that flames or smoke are not being produced, and treats a period in which the widths L₁ are not more than the predetermined threshold Lₘₐₓ as a flame/smoke non-production period.

The predetermined threshold Lₘₐₓ that is used may be a value obtained in advance by experiment, and may be a value that is calculated with the below expressions (9) and (10). The predetermined threshold Lₘₐₓ is larger than an empirical maximum value of widths of slag flows discharged from the slag outlet. Therefore, even when a value calculated by the below expressions (9) and (10) is used, the determination section may determine precisely whether or not at least one of flames and smoke is being produced.

$${L}_{max} = \frac{1}{2} D \qquad ( 9 )$$

$$D = \sqrt{\frac{4 A}{π}} \qquad ( 10 )$$

D: Circle equivalent diameter of the slag outlet (m)
A: Area of the slag outlet (m²)

Whether or not at least one of smoke and flames and smoke is being produced may also be determined from values of flow speed of the slag flow. This is because the slag flow descends vertically downward but flames and smoke rise vertically upward. Therefore, whether or not flames or smoke are being produced may be determined from a vertical upward speed component of the high-brightness material according to the image analysis.

### =Projection Section=

The projection section uses a width L₁ of the slag flow before the start of a duration of flame/smoke generation or before the start and after the end of a duration of flame/smoke generation to project a width L₂ of the slag flow in the duration of flame/smoke generation. As described above, a width L₁ of the slag flow measured by the measurement section in a duration of flame/smoke generation is measured as being greater than the actual width of the slag flow. Therefore, in order to suitably estimate a slag discharge amount in the duration of flame/smoke generation, the width L₂ of the slag flow in the duration of flame/smoke generation must be suitably projected. Accordingly, in the present exemplary embodiment, widths L₂ of the slag flow in a duration of flame/smoke generation are projected using widths L₁ of the slag flow just before the start of the duration of flame/smoke generation or just before the start and just after the end of the duration of flame/smoke generation. More specifically, methods (1) and (2) below are projection methods.

(1) The projection section may project the widths L₂ of the slag flow in the duration of flame/smoke generation by setting the widths L₂ to a width Lₑₛₜ of the slag flow that is calculated by the below expression (11).

$${L}_{est} = {( \frac{{t}_{f} - t}{{t}_{f} - {t}_{i}} )}^{B} \cdot {L}_{i} + {( \frac{t - {t}_{i}}{{t}_{f} - {t}_{i}} )}^{B} \cdot {L}_{f} \qquad ( 11 )$$

Lₑₛₜ: estimated width at a time t in the duration of flame/smoke generation (m)
Lᵢ: average value of N_{ref} widths L₁ before the start of the duration of flame/smoke generation (m)
L_{f}: average value of N_{ref} widths L₁ after the end of the duration of flame/smoke generation (m)
N_{ref}: number of samples of width L₁ for finding Lᵢ and L_{f}
tᵢ: start time of the duration of flame/smoke generation
t_{f}: end time of the duration of flame/smoke generation
B: set to 0<B<1 when the duration of flame/smoke generation is 8 s or more; set to B=1 when the duration of flame/smoke generation is less than 8 s

The number of samples N_{ref} of widths L₁ for finding Lᵢ and L_{f} is at least two. In order to improve slag discharge amount estimation accuracy, N_{ref} may be set to 10 or more. A maximum value of N_{ref} is not particularly limited, but may be not more than, for example, 30. Thus, because N_{ref} contains a predetermined range, before the start and after the end of the duration of flame/smoke generation are set by the number of samples N_{ref} and the capture interval of the still images.

Alternatively, a specific duration range may be designated for before the start and after the end of the duration of flame/smoke generation. For example, before the start and after the end of the duration of flame/smoke generation may be set to 5 s before the start and after the end of the duration of flame/smoke generation, may be set to 3 s and may be set to 1 S.

The constant B is in the range 0<B<1 when the duration of flame/smoke generation is eight seconds or more. In this case, the constant B to be used is calculated beforehand on the basis of actual masses of slag flows (masses measured by a weighing instrument). More specifically, firstly the parameter α that corrects for the cross-sectional shape of the slag flow is determined with a charge that does not produce flames. Then, when a duration of flame/smoke generation is eight seconds or more under the same conditions as the above charge, using the value of α, a value of B that fits actual masses of slag flows with slag discharge amounts estimated by the estimation section is found by fitting. Because the parameter α is invariable when measurement conditions are constant, the parameter α may be utilized to find values of B. When the constant B is in the range 0<B<1, expression (11) produces a function that joins the widths Lᵢ and L_{f} before the start and after the end of the duration of flame/smoke generation with an upward convex curve. When the duration of flame/smoke generation is less than eight seconds, the constant B is set to B=1. In this case, expression (11) produces a function that joins the widths Lᵢ and L_{f} before the start and after the end of the duration of flame/smoke generation with a straight line.

(2) Alternatively, the projection section calculates a gradient T of the widths L₁ of the slag flow in a duration (s) before the start of the duration of flame/smoke generation from a maximum value and minimum value of N_{ref} widths L₁ before the start of the duration of flame/smoke generation, or calculates the gradient T from N_{ref} widths L₁ before the start of the duration of flame/smoke generation by a least squares fit. The projection section determines whether or not the gradient T exceeds a predetermined threshold Tₛₗₒₚₑ. When the gradient T exceeds the threshold Tₛₗₒₚₑ, the projection section may project an average value Lᵢ of the N_{ref} widths L₁ of the slag flow before the start of the duration of flame/smoke generation to the widths L₂ of the slag flow in the duration of flame/smoke generation. When the gradient T is not more than the threshold Tₛₗₒₚₑ, the projection section may project a width Lₑₛₜ of the slag flow calculated by expression (11) to the widths L₂ of the slag flow in the duration of flame/smoke generation.

It is sufficient that the predetermined threshold Tₛₗₒₚₑ be at least 0. To improve slag discharge mass estimation accuracy, the predetermined threshold Tₛₗₒₚₑ may be set to 0.2 or more. A maximum value of the predetermined threshold Tₛₗₒₚₑ is not particularly limited but may be, for example, 300 or less. The predetermined threshold Tₛₗₒₚₑ is set as appropriate taking account of operation conditions, slag discharge mass estimation precision and the like.

While this projection method (2) encompasses the projection method (1), projection of the widths L₂ of the slag flow in the flame/smoke projection period differs between the methods depending on whether or not the gradient T of the widths L₁ of the slag flow exceeds the predetermined threshold Tₛₗₒₚₑ.

Projection methods (1) and (2) both raise slag flow estimation precision and are both excellent for this purpose. Projection method (1) or (2) may be assigned in accordance with operation conditions of a converter or electric furnace.

### =Estimation Section=

The estimation section estimates a slag discharge amount from the aforementioned expression (8).

When estimating a slag discharge amount in a duration of flame/smoke generation, the estimation section uses the widths L₂ of the slag flow projected by the projection section as the widths L of the slag flow in expression (8). When estimating a slag discharge amount in a flame/smoke non-production period, the estimation section uses the widths L₁ of the slag flow computed by the measurement section in the flame/smoke non-production period or a moving average Lₐᵥₑ of the widths L₁ of the slag flow in the flame/smoke non-production period. The number of widths L₁ used for calculating the moving average Lₐᵥₑ is not particularly limited but is, for example, between 5 and 30.

Thus, the estimation section changes the widths L used in expression (8) in accordance with whether or not at least one of flames and smoke is being produced. Therefore, the estimation section may estimate a slag discharge amount precisely regardless of whether or not at least one of flames and smoke is being produced.

### —Flowchart for Setting Widths L—

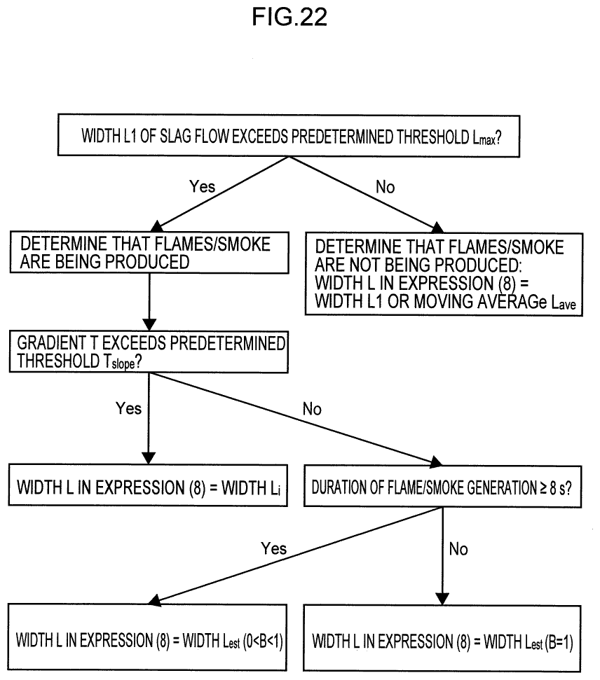

A flowchart for setting the widths L in expression (8) when the slag discharge amount estimation system is using projection method (2) is shown in FIG. 22.

As shown in FIG. 22, firstly the projection section makes a determination as to whether a width L₁ of the slag flow measured by the measurement section exceeds the predetermined threshold Lₘₐₓ. When the width L₁ is equal to or less than the predetermined threshold Lₘₐₓ (L₁≤Lₘₐₓ), it is determined that neither flames nor smoke is being produced, and the width L₁ or a moving average Lₐᵥₑ is employed as widths L to be used in expression (8). On the other hand, when the width L₁ is greater than the predetermined threshold Lₘₐₓ (L₁>Lₘₐₓ), it is determined that flames/smoke are being produced.

When it is determined that flames/smoke are being produced, the projection section makes a determination as to whether the gradient T of the width L₁ of the slag flow before the start of the duration of flame/smoke generation exceeds the threshold Tₛₗₒₚₑ. When the gradient T is greater than the threshold Tₛₗₒₚₑ (T>Tₛₗₒₚₑ), the widths Lᵢ are employed as widths L to be used in expression (8). When the gradient T is equal to or less than the threshold Tₛₗₒₚₑ (T≤Tₛₗₒₚₑ), the projection section makes a determination as to whether the duration of flame/smoke generation is at least 8 s.

When T≤Tₛₗₒₚₑ and the duration of flame/smoke generation is 8 s or more, the width Lₑₛₜ (with 0<B<1) is employed as the width L to be used in expression (8). When T≤Tₛₗₒₚₑ and the duration of flame/smoke generation is less than 8 s, the width Lₑₛₜ (with B=1) is employed as the width L to be used in expression (8).

In the exemplary embodiment described above, the detection section and the image capture section are provided at a single imaging device, but the slag discharge amount estimation system according to the present disclosure does not require this. In the exemplary embodiment, the detection section, measurement section, recording section, determination section, projection section and estimation section are provided at a single computer, but the slag discharge amount estimation system according to the present disclosure does not require this. The detection section, measurement section, recording section, determination section, projection section and estimation section may be provided at separate devices (for example, separate computers). Further, for example, the detection section may be provided at the imaging device. As long as the detection section, image capture section, measurement section, recording section, determination section, projection section and estimation section according to the present disclosure are provided, structures of equipment embodying the same are not particularly limited.

Above, a slag estimation system according to the present disclosure is described using the exemplary embodiment. According to the slag discharge amount estimation system of the present disclosure, because images of the slag flow being discharged from the refining vessel are analyzed by the given methods, slag discharge amounts may be estimated precisely regardless of whether or not at least one of flames and smoke is being produced. Because image analysis—a non-contact method—is employed, this slag discharge amount estimation system is economically more rational than a method in which slag discharge masses are weighed directly. That is, ease of maintenance and value for money may be improved compared to direct weighing.

### —Test Examples—

Table 1 shows conditions of Test Examples 1 to 13 that were conducted. Table 2 shows, as Examples, slag discharge amounts estimated using the estimation system according to the present disclosure. In Examples 1 to 13, states of slag flow from a converter were imaged by a camera capturing 30 still images per second. In Examples 1 to 11, the above-described projection method (1) was used. In Examples 12 and 13, the above-described projection method (2) was used. Slag discharge amounts estimated in accordance with conventional technology from furnace interior shapes, tilt angles and the like of electric furnaces are shown as Comparative Examples. Estimation errors were found from the above expression (5).

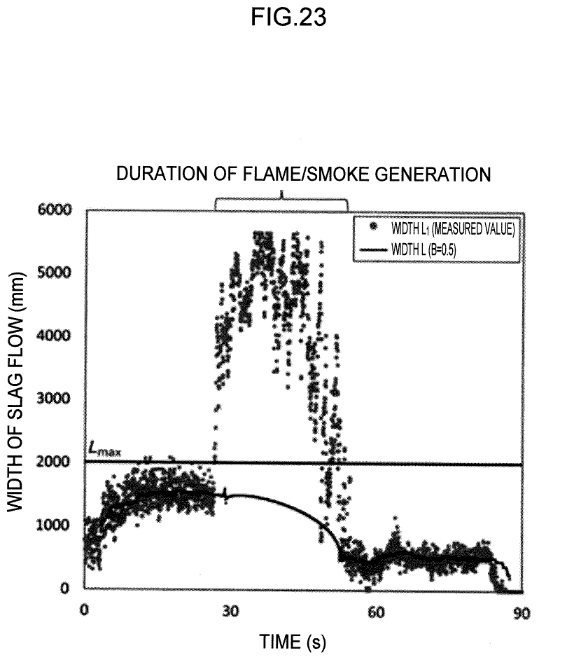

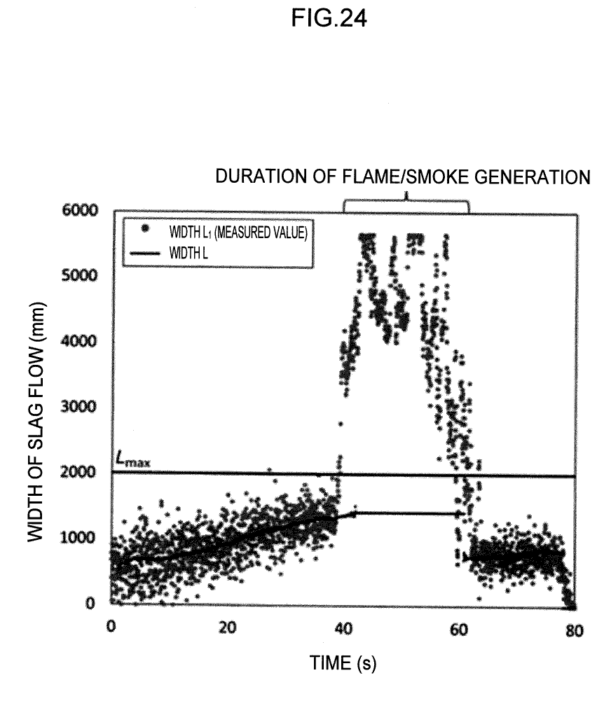

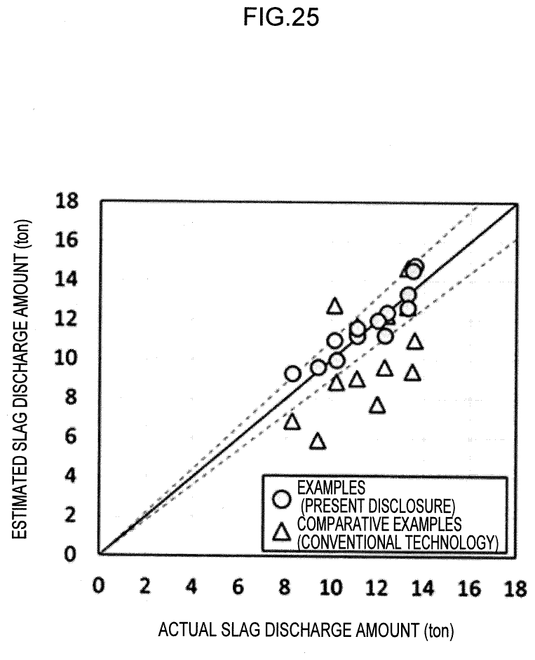

FIG. 23 is a graph showing changes over time in widths of the slag flow in one Test Example of Examples 1 to 11. FIG. 24 is a graph showing changes over time in widths of the slag flow in one Test Example of Examples 12 and 13. FIG. 25 depicts results showing a relationship between actual slag discharge amounts (measured by a weighing instrument) and estimated slag discharge amounts found in the Examples.

TABLE 6

| | Molten iron | Refining material | | | | | |
|---|---|---|---|---|---|---|---|
| No. | amount (ton) | charge amount (ton) | α | Δt (s) | Tₛₗₒₚₑ (m/s) | N_{ref} | B |
| 1 | 346.9 | 12.9 | 0.039 | 0.03 | 0.3 | 10 | 1 |
| 2 | 340.1 | 9 | 0.039 | 0.03 | 0.3 | 10 | 1 |
| 3 | 312.8 | 6.5 | 0.039 | 0.03 | 0.3 | 10 | 1 |
| 4 | 339.3 | 10.5 | 0.039 | 0.03 | 0.3 | 10 | 1 |
| 5 | 360.5 | 14.1 | 0.039 | 0.03 | 0.3 | 10 | 1 |
| 6 | 355.4 | 13.4 | 0.039 | 0.03 | 0.3 | 10 | 0.5 |
| 7 | 351.2 | 14.6 | 0.039 | 0.03 | 0.3 | 10 | 0.5 |
| 8 | 362.4 | 12.9 | 0.039 | 0.03 | 0.3 | 10 | 1 |
| 9 | 367.8 | 12.5 | 0.039 | 0.03 | 0.3 | 10 | 1 |
| 10 | 340.9 | 8.5 | 0.039 | 0.03 | 0.3 | 10 | 0.5 |
| 11 | 351.9 | 13.2 | 0.039 | 0.03 | 0.3 | 10 | 0.5 |
| 12 | 344.4 | 10.3 | 0.039 | 0.03 | 0.3 | 10 | — |
| 13 | 347.9 | 12.5 | 0.039 | 0.03 | 0.3 | 10 | — |

TABLE 7

| | | Example | | Comparative Example | |
|---|---|---|---|---|---|
| | Actual | Estimated | | Estimated | |
| | slag | slag | | slag | |
| | discharge | discharge | Estimation | discharge | Estimation |
| | amount | amount | error | amount | error |
| No. | (ton) | (ton) | (%) | (ton) | (%) |
| 1 | 12.4 | 12.41 | 0.0743 | 12.25 | 1.25 |
| 2 | 10.1 | 10.99 | 8.82 | 12.77 | 26.4 |
| 3 | 9.4 | 9.61 | 2.18 | 5.9 | 37.2 |
| 4 | 13.6 | 14.81 | 8.92 | 10.99 | 19.2 |
| 5 | 13.3 | 13.35 | 0.376 | 14.66 | 10.2 |
| 6 | 12.3 | 11.25 | 8.51 | 9.63 | 21.7 |
| 7 | 11.1 | 11.23 | 1.18 | 9.05 | 18.5 |
| 8 | 10.2 | 9.99 | 2.03 | 8.85 | 13.2 |
| 9 | 13.5 | 14.54 | 7.69 | 9.4 | 30.3 |
| 10 | 12 | 12.01 | 0.125 | 7.74 | 35.4 |
| 11 | 13.3 | 12.66 | 4.79 | 12.7 | 4.53 |
| 12 | 11.1 | 11.6 | 4.46 | 11.7 | 5.72 |
| 13 | 8.3 | 9.3 | 12.0 | 6.9 | 17.0 |
| | | Average | | Average | |
| | | estimation | | estimation | |
| | | error: 4.71% | | error: 18.5% | |

As shown in Table 7, the Examples estimated the slag discharge amounts more precisely than the Comparative Examples. It is confirmed that estimation errors found from the estimated amounts and actual amounts were smaller in the Examples and that, in this respect, the slag discharge amounts could be estimated more precisely.

As mentioned above, Examples 1 to 11 used projection method (1) and Examples 12 and 13 used projection method (2). The average estimation error for the Examples was 4.71%, whereas the average estimation error for the Comparative Examples was 18.5%. Thus, whichever projection method was utilized, slag discharge amounts could be projected precisely.

Preferable embodiments of the present disclosure have been described in detail while referring to the attached drawings, but the present disclosure is not limited by these examples. It will be clear to the ordinary practitioner in the field of art to which the present disclosure belongs that numerous modifications and improvements are possible within the scope of the technical gist recited in the attached claims, and it should be understood that these modifications and improvements are to be encompassed by the technical scope of the disclosure.

The following supplementary remarks are disclosed in relation to the exemplary embodiments described above.

### —Supplementary Remarks 1—

[1] A slag discharge amount estimation method includes: a capturing step of capturing a slag flow flowing out from a throat of a converter; a finding step of finding a volume flow rate or mass flow rate of the slag flow from captured images; and an estimating step of estimating a slag discharge amount from the converter on the basis of the volume flow rate or the mass flow rate.

[2] In the slag discharge amount estimation method according to [1], an imaging direction of an imaging device capturing the slag flow is angled relative to a discharge direction of the converter in plan view.

[3] In the slag discharge amount estimation method according to [2], the imaging direction of the imaging device capturing the slag flow is orthogonal to the vertical direction as seen from sideward.

[4] In the slag discharge amount estimation method according to any one of [1] to [3], the finding step includes: finding a width L (m) at a predetermined height of the slag flow from an image capturing the slag flow and a distance H (m) from a position of measurement of the width L to a flow start position of the slag flow from the throat; finding a cross-sectional area S (m²) of the slag flow at the position of measurement, which cross-sectional area S is απL²; finding a flow speed V (m/s) at the position of measurement by assuming that the flow speed V is a freefall rate of the slag flow of (2gH)^{0.5}; and finding a volume flow rate Q (m³/s) of the slag flow by expression (1):

$$Q = SV = α π {L}^{2} V = α π {{L}^{2} ( 2 gH )}^{0.5} . \qquad ( 1 )$$

[5] The slag discharge amount estimation method according to [4] includes using a bulk density ρ (kg/m³) that is found geometrically to convert the volume flow rate to a mass flow rate ρQ (kg/s), and finding the slag discharge mass (kg) from an integrated value ΣρQ (kg), the bulk density ρ being found from at least a tilt angle of the converter when the slag flow starts to flow out, a shape of the converter, a volume of the converter, and the volume flow rate.

[6] The slag discharge amount estimation method according to [4] or [5] further includes finding α by parameter fitting so as to fit slag discharge masses (kg) found using a weighing instrument at times of discharge from the refining vessel with integrated values ΣρQ (kg) of mass flow rates ρQ (kg/s).

[7] A refining method includes setting an operation condition in a subsequent step on the basis of a slag discharge amount estimated by the estimation method according to any one of [1] to [6].

[8] A refining method includes: capturing a slag flow flowing out from a throat of a converter; finding a width of the slag flow from a captured image; and setting an operation condition in a subsequent step on the basis of the width that is found.

[9] In the refining method according to [7] or [8], the operation condition includes a type of refining material to be added to a molten metal in the converter and an addition amount of the refining material.

### —Supplementary Remarks 2—

[1] A slag discharge amount estimation system for an electric furnace includes: a detection section that detects a slag flow flowing out from the electric furnace; an image capture section that captures the slag flow when the slag flow is detected; a calculation section that finds a volume flow rate of the slag flow from captured images; and an estimation section that estimates a slag amount flowing out from the electric furnace on the basis of the volume flow rate.

[2] In the slag discharge amount estimation system for an electric furnace according to [1], the detection section measures brightness values expressed in 256 gradations and detects high-brightness material whose brightness values are at least 30 gradations more than a background as being the slag flow.

[3] In the slag discharge amount estimation system for an electric furnace according to [1] or [2], the volume flow rate Q (m³/s) of the slag flow is found by the following expression (1):

$$Q = SV = α π {L}^{2} V \qquad ( 1 )$$

Q: volume flow rate of the slag flow (m³/s)
S: cross-sectional area of the slag flow at the position of measurement of the width L (m²)
V: flow speed V of the slag flow at the position of measurement of the width L (m/s)
α: parameter for correcting the cross-sectional shape of the slag flow
α: parameter for correcting the cross-sectional shape of the slag flow
L: width of the slag flow calculated from the images capturing the slag flow (m).

[4] In a slag discharge amount estimation method for an electric furnace according to [3], the estimation section finds a bulk density ρ (kg/m³) by the following expression (2) and finds a mass M (kg) of the slag flow by the following expression (3):

$$ρ = ρ L \cdot ( 100 - φ ) / 100 \qquad ( 2 )$$

$$M = ρ \cdot \sum ( Δ t \cdot Q ) \qquad ( 3 )$$

ρ: bulk density of the slag (kg/m³)
ρL: density of uniform liquid phase slag (kg/m³)
φ: gas phase fraction in the slag, calculated from a change in slag thickness between an electrification start time of the electric furnace and a time the slag flows out
Δt: interval between image capture times (s).

[5] In the slag discharge amount estimation system for an electric furnace according to [3], the calculation section finds a distance H (m) from a position of measurement of the width L of the slag flow to a flow start position of the electric furnace, and finds the flow speed V by assuming a freefall rate of the slag flow of (2gH)^{0.5} as the flow speed V (m/s) at the position of measurement of the width L.

[6] In the slag discharge amount estimation system for an electric furnace according to [3], the calculation section finds a movement distance of the slag flow by position matching from at least two of the images, and finds the flow speed V (m/s) at the position of measurement of the width L by dividing a difference (s) between times of capture of the images from which the movement distance is found by the movement distance of the slag flow.

[7] In the slag discharge amount estimation system for an electric furnace according to [3], the calculation section sets the parameter α by parameter fitting using theoretical slag discharge amounts (kg) calculated from mass balances of components constituting the slag or slag discharge amounts (kg) measured by a weighing instrument as true values.

[8] A refining process in an electric furnace includes adjusting at least one of a type of a refining material to be added in the electric furnace, an addition amount of the refining material, a voltage, a current and an electrode height on the basis of a slag discharge amount estimated by the slag discharge amount estimation system according to [1] or [2].

### —Supplementary Remarks 3—

A slag discharge amount estimation method includes: capturing a slag flow flowing out from a refining vessel; finding a width of the slag flow from a captured image; and estimating a slag discharge amount. The slag discharge amount estimation method includes, when the slag flow is divided into a plurality of flows in the captured image, finding respective widths of the slag flow divisions and using a total of the widths that are found to estimate the slag discharge amount.

[2] In the slag discharge amount estimation method according to [1], the slag discharge amount is found by the following expression (1):

$$M = ρ \cdot Δ t \cdot \sum \{ α \cdot π \cdot {( \sum {L}_{i} )}^{2} \cdot {V}_{1} \} \qquad ( 1 )$$

M: slag discharge mass (kg)
ρ: bulk density of the slag (kg/m³)
Δt: time interval between images (s)
α: parameter for correcting the cross-sectional shape of the slag flow
Lᵢ: Width of a slag flow division (m)
V₁: Average of flow speeds of the slag flow divisions, flow speed of one of the slag flow divisions, or respective flow speeds of the slag flow divisions.

[3] A slag discharge amount estimation method includes: capturing a slag flow flowing out from a refining vessel; finding a width of the slag flow from a captured image; and estimating a slag discharge amount. The slag discharge amount estimation method includes, when the slag flow is divided into a plurality of flows in the captured image, finding respective widths of the slag flow divisions, using the widths that are found to estimate respective slag discharge amounts, and estimating a total slag discharge amount from the estimated slag discharge amounts.

[4] In the slag discharge amount estimation method according to [3], the slag discharge amount is found by the following expression (2):

$$M = \sum {M}_{i} = ρ \cdot Δ t \cdot \sum ( α \cdot π {L}_{i}^{2} \cdot {V}_{2} ) \qquad ( 2 )$$

M: slag discharge mass (kg)
Mᵢ: slag discharge mass of a slag flow division (kg)
ρ: bulk density of the slag (kg/m³)
Δt: time interval between images (s)
α: parameter for correcting the cross-sectional shape of the slag flow
Lᵢ: Width of a slag flow division (m)
V₂: Average of flow speeds of the slag flow divisions, flow speed of one of the slag flow divisions, or respective flow speeds of the slag flow divisions.

[5] In the slag discharge amount estimation method according to any one of [1] to [4], the slag flow is captured by an imaging device to which at least one of a bandpass filter, which selectively transmits a wavelength range in a range from the visible light region to the infrared region, and a light dimming filter, which reduces incident light amounts, is attached.

[6] A slag discharge amount estimation system includes an imaging device that captures a slag flow flowing out from a refining vessel, and an estimation device that finds a width of the slag flow from a captured image and estimates a slag discharge amount, in which the estimation device, when the slag flow is divided into a plurality of flows in the captured image: finds respective widths of the slag flow divisions; and uses a total of the widths that are found to estimate a slag discharge amount, or uses the widths that are found to estimate respective slag discharge amounts of the flow divisions and estimates a total slag discharge amount from the estimated slag discharge amounts.

[7] In the slag discharge amount estimation system according to [6], at least one of a bandpass filter, which selectively transmits a wavelength range in a range from the visible light region to the infrared region, and a light dimming filter, which reduces incident light amounts, is attached to the imaging device.

### —Supplementary Remarks 4—

[1] A slag discharge amount estimation method includes: capturing a slag flow flowing out from a refining vessel; finding a width of the slag flow from a captured image; and estimating a slag discharge amount. The slag discharge amount estimation method includes limiting incident light amounts on an imaging device capturing the slag flow, distinguishing the slag flow from a flame that occurs during the slag discharge by a brightness difference in the captured image between the slag flow and the flame, and finding the width of the slag flow.

[2] In the slag discharge amount estimation method according to [1], the slag discharge amount is found by the following expression (1):

$$M = ρ \cdot Δ t \cdot \sum απ {L}^{2} \cdot V \qquad ( 1 )$$

M: slag discharge mass (kg)
ρ: bulk density of the slag (kg/m³)
Δt: time interval between images (s)
α: parameter for correcting the cross-sectional shape of the slag flow
L: width of the slag flow (m)
V: flow speed of the slag flow (m/s).

[3] In the slag discharge amount estimation method according to [1], the slag flow is captured by the imaging device, to which a limiting filter that limits incident light amounts is attached.

[4] The slag discharge amount estimation method according to any one of [1] to [3] includes, when the slag flow is divided into a plurality of flows in the captured image, finding respective widths of the slag flow divisions and using a total of the widths that are found to estimate the slag discharge amount.

[5] The slag discharge amount estimation method according to any one of [1] to [3] includes, when the slag flow is divided into a plurality of flows in the captured image, finding respective widths of the slag flow divisions, using the widths that are found to estimate respective slag discharge amounts, and estimating a total slag discharge amount from the estimated slag discharge amounts.

[6] The slag discharge amount estimation method according to any one of [1] to [3] includes capturing a region at an upstream side of the slag flow with the imaging device.

[7] The slag discharge amount estimation method according to any one of [1] to [3] includes using a region at an upstream side of images capturing the slag flow to find the widths of the slag flow.

[8] A slag discharge amount estimation system includes: an imaging device that captures a slag flow flowing out from a refining vessel; and an estimation device that finds a width of the slag flow from a captured image and estimates a slag discharge amount. In the slag discharge amount estimation system, the imaging device limits incident light amounts, and the estimation device distinguishes the slag flow from a flame that occurs during the slag discharge by a brightness difference in the captured image between the slag flow and the flame, and finds the width of the slag flow.

### —Supplementary Remarks 5—

[1] A slag discharge amount estimation system includes: a detection section that detects a slag flow of slag flowing out from a refining vessel; an image capture section that captures the slag flow when the slag flow is detected; a measurement section that measures a width L₁ of the slag from a captured still image; a recording section that records changes over time of the measured widths L₁ of the slag flow; a determination section that determines that a period in which the width L₁ of the slag flow in the changes over time of the width L₁ of the slag flow exceeds a predetermined threshold Lₘₐₓ is a duration of flame/smoke generation in which flames or smoke are produced, and determines that a period in which the width L₁ of the slag flow is less than the predetermined threshold Lₘₐₓ is a flame/smoke non-production period in which neither flames nor smoke is produced; a projection section that uses a width L₁ of the slag flow before the start of a duration of flame/smoke generation or before the start and after the end of a duration of flame/smoke generation to project a width L₂ of the slag flow in the duration of flame/smoke generation; and an estimation section that estimates a slag discharge amount by the following expression (1). When estimating a slag discharge amount in a duration of flame/smoke generation, the estimation section uses the width L₂ of the slag flow projected by the projection section as a width L of the slag flow in expression (1), and when estimating a slag discharge amount in a flame/smoke non-production period, the estimation section uses the width L₁ of the slag flow computed by the measurement section in the flame/smoke non-production period or a moving average Lₐᵥₑ of the widths L₁ of the slag flow in the flame/smoke non-production period:

$$M = ρ \cdot \sum Δ t \cdot απ {L}^{2} \cdot V \qquad ( 1 )$$

M: slag discharge mass (kg)
ρ: bulk density of the slag (kg/m³)
Δt: time interval between still images (s)
α: parameter for correcting the cross-sectional shape of the slag flow
L: width of the slag flow (m)
V: flow speed of the slag flow (m/s).

[2] In the slag discharge amount estimation system according to [1], the predetermined threshold Lₘₐₓ at the determination section is a value calculated by the following expressions (2) and (3):

$${L}_{max} = \frac{1}{2} D \qquad ( 2 )$$

$$D = \sqrt{\frac{4 A}{π}} \qquad ( 3 )$$

D: circle equivalent diameter of the slag outlet provided at the refining vessel (m)
A: area of the slag outlet (m²).

[3] In the slag discharge amount estimation system according to [1] or [2], the projection section projects the width L₂ of the slag flow in the duration of flame/smoke generation by setting the width L₂ to a width Lₑₛₜ of the slag flow that is calculated by the following expression (4):

$${L}_{est} = {( \frac{{t}_{f} - t}{{t}_{f} - {t}_{i}} )}^{B} \cdot {L}_{i} + {( \frac{t - {t}_{i}}{{t}_{f} - {t}_{i}} )}^{B} \cdot {L}_{f} \qquad ( 4 )$$

Lₑₛₜ: estimated width at a time t in the duration of flame/smoke generation (m)
Lᵢ: average value of N_{ref} widths L₁ before the start of the duration of flame/smoke generation (m)
L_{f}: average value of N_{ref} widths L₁ after the end of the duration of flame/smoke generation (m)
N_{ref}: number of samples of width L₁ for finding Lᵢ and L_{f}
tᵢ: start time of the duration of flame/smoke generation
t_{f}: end time of the duration of flame/smoke generation
B: set to 0<B<1 when the duration of flame/smoke generation is 8 s or more; set to B=1 when the duration of flame/smoke generation is less than 8 s.

[4] In the slag discharge amount estimation system according to [3], the projection section: calculates a gradient T of widths L₁ of the slag flow in a duration (s) before the start of the duration of flame/smoke generation from a maximum value and minimum value of N_{ref} widths L₁ before the start of the duration of flame/smoke generation, or calculates the gradient T from N_{ref} widths L₁ before the start of the duration of flame/smoke generation by a least squares fit; determines whether or not the gradient T exceeds a predetermined threshold Tₛₗₒₚₑ; when the gradient T exceeds the threshold Tₛₗₒₚₑ, projects an average value Li of the N_{ref} widths L₁ of the slag flow before the start of the duration of flame/smoke generation to the widths L₂ of the slag flow in the duration of flame/smoke generation, and when the gradient T is not more than the threshold Tₛₗₒₚₑ, projects a width Lₑₛₜ of the slag flow calculated by expression (4) to the widths L₂ of the slag flow in the duration of flame/smoke generation.

[5] In the slag discharge amount estimation system according to [1] or [2], the detection section measures brightness values expressed in 256 gradations, and detects high-brightness material whose brightness values are at least 30 gradations more than a background as being the slag flow.

[6] In the slag discharge amount estimation system according to [1] or [2], a distance H (m) from a position of measurement of the width L₁ of the slag flow by the measurement section to a lower end of the slag outlet is found, and the flow speed V of the slag flow is calculated by assuming a freefall rate of the slag flow of (2gH)^{0.5} as the flow speed V.

[7] In the slag discharge amount estimation system according to [1] or [2], the flow speed V of the slag flow is a quotient for which a movement distance of the slag flow that is found by position matching from at least two of the still images is divided by a difference (s) between times of capture of the still images.

[8] In the slag discharge amount estimation system according to [1] or [2], the parameter α is set to a value calculated by parameter fitting using theoretical slag discharge amounts (kg) calculated from mass balances of components constituting the slag or slag discharge amounts (kg) measured by a weighing instrument as true values.

The disclosures of Japanese Patent Application Nos. 2022-147356 filed Sep. 15, 2022 and 2022-211373 filed Dec. 28, 2022 are incorporated into the present specification by reference in their entirety. All references, patent applications and technical specifications cited in the present specification are incorporated by reference into the present specification to the same extent as if the individual references, patent applications and technical specifications were specifically and individually recited as being incorporated by reference.

1. A slag discharge amount estimation method comprising:
capturing a slag flow flowing out from an outlet of a refining vessel with a single imaging device, an upstream side of the slag flow being wider in width than a downstream side;
finding widths of the slag flow from captured images and finding a volume flow rate or mass flow rate of the slag flow; and
estimating a slag discharge amount based on the volume flow rate or the mass flow rate that is found.

2. The slag discharge amount estimation method according to claim 1, further comprising:
finding:
a width L (m) at a predetermined height of the slag flow from an image capturing the slag flow, and
a distance H (m) from a position of measurement at which the width L is measured to a flow start position of the slag flow from the outlet;
finding a cross-sectional area S (m²) of the slag flow at the position of measurement, the cross-sectional area S being απL²;
finding a flow speed V (m/s) at the position of measurement; and
finding a volume flow rate Q (m³/s) of the slag flow by expression (1):
$$Q = SV = α π {L}^{2} V . \qquad ( 1 )$$

3. The slag discharge amount estimation method according to claim 2, wherein finding the flow speed V includes:
assuming a freefall rate of the slag flow of (2gH)^{0.5} as the flow speed V, or
measuring a movement distance of the slag flow by pattern matching.

4. The slag discharge amount estimation method according to claim 3, further comprising:
using a bulk density ρ (kg/m³) that is found geometrically to convert the volume flow rate to a mass flow rate ρQ (kg/s); and
finding the slag discharge mass (kg) from an integrated value ΣρQ (kg).

5. The slag discharge amount estimation method according to claim 3, further comprising finding α by parameter fitting so as to fit slag discharge masses (kg) found using a weighing instrument at times of discharge from the refining vessel with integrated values ΣρQ (kg) of mass flow rates ρQ (kg/s).

6. The slag discharge amount estimation method according to claim 1, further comprising:
monitoring slag flowing out from the outlet of the refining vessel with the imaging device; and
when slag flowing out from the outlet is detected, starting the capturing of the slag flow with the imaging device.

7. The slag discharge amount estimation method according to claim 6, further comprising, when a material with brightness values higher than a background by at least a predetermined amount is identified in an imaging region of the imaging device, detecting the material as the slag flow.

8. The slag discharge amount estimation method according to claim 1, further comprising, when the slag flow is divided into a plurality of flows in an image capturing the slag flow:
finding widths of slag flow divisions; and
using a total of the widths that are found to estimate the slag discharge amount.

9. The slag discharge amount estimation method according to claim 1, further comprising, when the slag flow is divided into a plurality of flows in an image capturing the slag flow:
finding widths of slag flow divisions;
using the widths that are found to estimate respective slag discharge amounts of the slag flow divisions; and
estimating a total slag discharge amount from the estimated slag discharge amounts.

10. The slag discharge amount estimation method according to claim 1, wherein a bandpass filter that selectively transmits a wavelength range from the visible light region to the infrared region is attached to the imaging device capturing the slag flow.

11. The slag discharge amount estimation method according to claim 1, wherein a limiting filter that limits incident light amounts is attached to the imaging device capturing the slag flow.

12. The slag discharge amount estimation method according to claim 1, wherein the imaging device captures a region at the upstream side of the slag flow.

13. The slag discharge amount estimation method according to claim 1, wherein a region at the upstream side of the captured images of the slag flow is used to find the widths of the slag flow.

14. The slag discharge amount estimation method according to claim 1, further comprising, when estimating a slag discharge amount in a non-production period in which neither flames nor smoke is being produced:
measuring a width of the slag flow at a predetermined position of a captured image, and
using the measured value or a moving average of the measured widths as the width of the slag flow.

15. The slag discharge amount estimation method according to claim 1, further comprising, when estimating a slag discharge amount in a production period in which at least one of flames and smoke is being produced, projecting the width of the slag flow, including using:
a width of the slag flow found from an image captured before a start of the production period, or
widths of the slag flow found from images respectively captured before the start and after an end of the production period.

16. The slag discharge amount estimation method according to claim 15, wherein the production period is a period in which a width of the slag flow, in changes over time of the width of the slag flow, exceeds a predetermined width.

17. The slag discharge amount estimation method according to claim 16, wherein the predetermined width is represented by Lₘₐₓ, and Lₘₐₓ is found by expression (2) and expression (3)
$${L}_{max} = 1 / 2 D \qquad ( 2 )$$
$$D = √ 4 A / π \qquad ( 3 )$$
D: circle equivalent diameter of the slag outlet provided at the refining vessel (m)
A: area of the slag outlet (m²).

18. The slag discharge amount estimation method according to claim 15, wherein a width Lₑₛₜ of the slag flow found by expression (4) is used as the width of the slag flow
$${L}_{est} = {( \frac{{t}_{f} - t}{{t}_{f} - {t}_{i}} )}^{B} \cdot {L}_{i} + {( \frac{t - {t}_{i}}{{t}_{f} - {t}_{i}} )}^{B} \cdot {L}_{f} \qquad ( 4 )$$
Lₑₛₜ: estimated width of the slag flow at a time t in the duration of flame/smoke generation (m)
Lᵢ: average value of N_{ref} widths of the slag flow before the start of the duration of flame/smoke generation (m)
L_{f}: average value of N_{ref} widths of the slag flow after the end of the duration of flame/smoke generation (m)
N_{ref}: number of samples of width of the slag flow for finding Lᵢ and L_{f}
tᵢ: start time of the duration of flame/smoke generation
t_{f}: end time of the duration of flame/smoke generation
B: set to 0<B<1 when the duration of flame/smoke generation is 8 s or more; set to B=1 when the duration of flame/smoke generation is less than 8 s.

19. The slag discharge amount estimation method according to claim 14, further comprising:
comparing a gradient T of widths of the slag flow with a threshold Tₛₗₒₚₑ; and
altering a projection of the width of the slag flow depending on whether or not the gradient T exceeds the threshold Tₛₗₒₚₑ.
